(19) United States
(12) Patent Application Publication
(10) Pub. No.: US 2026/0320943 A1
(43) Pub. Date: Oct. 15, 2026

(54) METHODS, SYSTEMS, AND COMPUTER PROGRAM PRODUCTS FOR ALIGNMENT OF A WEARABLE DEVICE

(71) Applicant: Magic Leap, Inc., Plantation, FL (US)

(72) Inventors: Alessandro PECORARO, Zurich (CH); Agostino GIBALDI, Modena (IT); Michael Jason SEGURA, Zurich (CH); Anusha SINGH, Fort Lauderdale, FL (US); Madhumitha Shankar MAHADEVAN, Pflugerville, TX (US); Bjorn Nicolaas Servatius VLASKAMP, Seattle, WA (US); Nukul Sanjay SHAH, Plantation, FL (US); Ivan Li Chuen YEOH, Wesley Chapel, FL (US); Jacobus DUIJNHOUWER, Fort Lauderdale, FL (US)

(73) Assignee: Magic Leap, Inc., Plantation, FL (US)

(21) Appl. No.: 19/113,697

(22) PCT Filed: Sep. 22, 2023
(86) PCT No.: PCT/US2023/074929

§ 371 Date: Mar. 20, 2025

Related U.S. Application Data
(60) Provisional application No. 63/376,976, filed on Sep. 23, 2022.

(51) Int. Cl. G06T 19/20; G06V 40/18

(52) U.S. Cl. CPC G06T 19/20; G06V 40/193; G06T 2219/2004

(57) ABSTRACT

Aligning extended-reality (XR) systems may present a first target at a closer, first location and a second target at a farther, second location to a user using the XR device, align the first and the second targets to each other with an alignment process, and determine a nodal point for an eye of the user based at least in part upon the first and the second target. Aligning extended-reality (XR) system may spatially register a set of targets in display portion of a user interface of the XR device comprising an adjustment mechanism that is used to adjust a relative position of the XR device to a user, trigger execution of a device fit process in response to receiving a device fit check signal, and adjust a relative position of the XR device to the user based on the device fit process.

### CROSS-REFERENCE TO RELATED APPLICATION(S)

The present application claims the benefit of U.S. Prov. Pat. App. Ser. No. 63/376,976 filed on Sep. 23, 2022 and entitled “METHODS, SYSTEMS, AND COMPUTER PROGRAM PRODUCTS FOR ALIGNMENT OF A WEARABLE DEVICE”. The content of the aforementioned U.S. provisional application is hereby expressly incorporated by reference in its entirety for all purposes.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Modern computing and display technologies have facilitated the development of systems for so-called “virtual-reality” (VR), “augmented reality” (AR) experiences, “mixed-reality” (MR) experiences, and/or extended-reality (XR) experiences (hereinafter collectively referred to as “extended-reality” and/or “XR”), where digitally reproduced images or portions thereof are presented to a user in a manner where they seem to be, or may be perceived as, real. A VR scenario typically involves presentation of digital or virtual image information without transparency to other actual real-world visual input, whereas an AR or MR scenario typically involves presentation of digital or virtual image information as an augmentation to visualization of the real world around the user such that the digital or virtual image (e.g., virtual content) may appear to be a part of the real world. However, MR may integrate the virtual content in a contextually meaningful way, whereas AR may not.

Applications of extended-reality technologies have been expanding from, for example, gaming, military training, simulation-based training, etc. to productivity and content creation and management. An extended-reality system has the capabilities to create virtual objects that appear to be, or are perceived as, real. Such capabilities, when applied to the Internet technologies, may further expand and enhance the capability of the Internet as well as the user experiences so that using the web resources is no longer limited by the planar, two-dimensional representation of web pages.

With the advent of XR systems and devices and the development therefor, XR systems and devices may bring about revolution to information technology and expand the applications of XR technologies to a new era beyond conventional applications such as gaming or mere Web browsing. For example, by hosting productivity software applications locally on XR systems or devices, by providing productivity software applications as services and/or microservices through, for example, a cloud-based environment to XR systems or devices, or a combination of locally hosted productivity software application(s) and cloud-based software services may simply revolutionize conventional ways of corporate work culture, office arrangement, the manners in which co-workers collaborate and/or perform their daily productivity tasks, etc. For example, a business entity may adopt XR devices to replace conventional desktop computers and/or laptop computers. Although the benefits may be numerous, management a fleet of XR devices and systems for enterprise applications of XR technologies is nevertheless lacking.

Therefore, there exists a need for methods, systems, and computer program products for extended-reality systems management.

### SUMMARY

Disclosed are method(s), system(s), and article(s) of manufacture for aligning extended-reality systems in one or more embodiments. Some embodiments are directed at a method for aligning extended-reality systems.

In some embodiments, these techniques present a first target at a first location and a second target at a second location to a user using an extended-reality (XR) device, wherein the first target is perceived as closer to the user than the second target is perceived, align the first target and the second target to each other at least by performing an alignment process that moves the first target or the second target presented to the user, and determine a nodal point for an eye of the user based at least in part upon the first and the second target.

In some of these embodiments, determining the nodal point for the eye of the user may determine a first line connecting the first target and the second target and determine the nodal point for the eye along the line based at least in part upon a first depth pertaining to the first target or a second depth pertaining to the second target.

In some of the above embodiments, determining the nodal point for the eye of the user may present a third target at a third location and a fourth target at a fourth location to the user, wherein the third target is perceived as closer to the user than the fourth target is perceived and determine a second line connecting the third and the fourth target.

In some of the immediately preceding embodiments, determining the nodal point for the eye of the user may determine the nodal point for the eye based at least in part upon the first line and the second line and provision one or more virtual input modules to user or the authorized user for the management software application.

In some embodiments, aligning the first target and the second target to each other may identify a pixel coordinate system for the XR device, present the first target at a fixed location in the pixel coordinate system to the user using the XR device, and present the second target at a moveable location to the user using the XR device, the fixed location being closer to the user than the moveable location.

In some of these embodiments, aligning the first target and the second target to each other may align the first target to the second target as perceived by the user by adjusting the moveable location to an adjusted location and determine a three-dimensional (3D) location of the nodal point of the eye for the user based at least in part on the first fixed location and the adjusted location.

In some of the immediately preceding embodiments, aligning the first target and the second target to each other may identify a pixel coordinate system for the XR device, present the first target at a moveable location to the user using the XR device, and present the second target at a fixed location in the pixel coordinate system to the user using the XR device, the moveable location being closer to the user than the fixed location.

In addition or in the alternative, aligning the first target and the second target to each other may align the first target to the second target as perceived by the user by adjusting the moveable location to an adjusted location, and determine a three-dimensional (3D) location of the nodal point of the eye for the user based at least in part on the fixed location and the adjusted location.

In some embodiments, aligning the first target and the second target to each other may identify a pixel coordinate system and a world coordinate system for the XR device, present the first target at a first fixed location in the pixel coordinate system to the user using the XR device, and present the second target at a second fixed location in the world coordinate system to the user using the XR device, the first fixed location being closer to the user than the second fixed location.

In some of the above embodiments, aligning the first target and the second target to each other may align the first target to the second target as perceived by the user and determine a three-dimensional (3D) location of the nodal point of the eye for the user based at least in part on the first fixed location, the second fixed location, and a result of aligning the first target to the second target.

In some embodiments, aligning the first target and the second target to each other may identify a pixel coordinate system and a world coordinate system for the XR device, present the first target at a first fixed location in the world coordinate system to the user using the XR device, and present the second target at a second fixed location in the pixel coordinate system to the user using the XR device, the first fixed location being closer to the user than the second fixed location.

In some of the immediately preceding embodiments, aligning the first target and the second target to each other may align the first target to the second target as perceived by the user, and determine a three-dimensional (3D) location of the nodal point of the eye for the user based at least in part on the first fixed location, the second fixed location, and a result of aligning the first target to the second target.

Some embodiments are directed to methods for aligning an extended-reality (XR) device that presents a first target at a first location and a second target at a second location to a user using an extended-reality (XR) device, wherein the first target is perceived as closer to the user than the second target is perceived, aligns the first target and the second target to each other at least by performing an alignment process that moves the first target or the second target presented to the user, and determines a nodal point for an eye of the user based at least in part upon the first and the second target.

In some embodiments, triggering the execution of the device fit process may receive a head pose signal indicating a head pose of a user wearing the XR device; determine whether the set of targets is within a field of view of the user based at least in part upon the head pose signal; and in response to determining that the set of targets is within the field of view of the user, receive a gazing signal indicating a gaze direction of the user and determined based at least in part on one or more calculated gazing directions of one or both eyes of the user.

In some of these embodiments, triggering the execution of the device fit process may determine whether the user is gazing at the set of targets for over a threshold time period based at least in part upon the gazing signal and in response to determining that the user is gazing at the set of targets over the threshold time period, trigger execution of a device fit check process.

In some embodiments, receiving the head pose signal may determine the head pose signal based at least in part upon position data and orientation data of the XR device; determine the position data using a world coordinate system; and determine the orientation data using a local coordinate system.

In some embodiments, a device fit process may present a first target in the set of targets at a first location to the user, present a second target in the set of targets at a second location to the user, the user perceiving the first target to be closer to the user than the second target, and transmit a signal to the XR device to cause one or both pupils of the user to contract.

In some of these embodiments, transmitting the signal to the XR device may increase brightness of display to one or both pupils of the user or trigger a light source to illuminate at least the one or both pupils of the user.

In addition or in the alternative, transmitting the signal to the XR device may align the first target and the second target to each other as perceived by the user at least by adjusting a relative position into an adjusted relative position of the XR device to the user with the adjustment mechanism; and calibrate an eye tracking model based at least the first location of the first target and the second location of the second target.

In some embodiments, calibrating the eye tracking model may identify a predicted nodal point produced by the eye tracking model for the eye of the user; and determine a nodal point of the eye of the user based at least in part upon the first location of the first target and the second location of the second target.

In some of the above embodiments, calibrating the eye tracking model may further determine whether the predicted nodal point is within an eye-box for the eye when the XR device is adjusted to the adjusted relative position; and in response to determining that the predicted nodal point is within the eye-box for the eye, skip calibration of the predicted nodal point.

In some of the above embodiments, calibrating the eye tracking model may further calibrate the nodal point and the predicted nodal point with respect to each other; and set the nodal point as the predicted nodal point for the eye tracking model, determining an average or a weighted average point between the nodal point and the predicted nodal point based at least in part upon close proximity of the nodal point and the predicted nodal point to a nominal center of the eye-box.

Some embodiments are directed to a method or process that presents, by an extended-reality device, a first target at a first location and a second target at a second location to a user, wherein the first target is perceived as closer to the user than the second target. The first target and the second target may be aligned with each other at least by performing an alignment process that moves the first target or the second target relative to the user. A nodal point may be determined for an eye of the user based at least in part upon the first target and the second target.

In some of these embodiments, determining the nodal point for the eye includes determining a first line or line segment connecting the first target and the second target. The nodal point may be determined for the eye along the first line or the line segment based at least in part upon a first depth pertaining to the first target or a second depth pertaining to the second target. A third target at a third location and a fourth target at a fourth location to the user, wherein the third target is perceived as closer to the user than the fourth target.

In some of the immediately preceding embodiments, determining the nodal point for the eye may further comprise determining a second line or line segment connecting the third target and the fourth target. The nodal point may be determined for the eye based at least in part upon the first line or line segment and the second line or line segment.

Some embodiments are directed to a method or process that identifies pixel coordinates for an extended-reality device, determines a first set of pixel coordinates for a first location of a first target, and presents, by the extended-reality device, the first target at the first set of pixel coordinates and a second target at a second location to a user. The first target and the second target may be aligned with each other as perceived by the user.

In some of these embodiments, a three-dimensional location may be determined for a nodal point of an eye for the user based at least in part upon a result of aligning the first target with the second target. In some of the immediately preceding embodiments, a second set of pixel coordinates may be determined for the second location of the second target. In some of these embodiments, the first location comprises a fixed location, and the second location comprises a movable location. In some other embodiments, the first location comprises a movable location, and the second location comprises a fixed location. Yet in some embodiments, the first location comprises a first fixed location, and the second location comprises a second fixed location, and the three-dimensional location of the nodal point is determined based at least in part upon the first fixed location, the second fixed location, and a result of aligning the first target to the second target as perceived by the user.

In some embodiments, identifying the pixel coordinates for the extended-reality device may further comprise identifying world coordinates for the extended-reality device. A set of world coordinates for the second location of the target, wherein the first target is presented at the first set of pixel coordinates for the extended-reality device as perceived by the user, and the second target is presented at the set of world coordinates as perceived by the user.

In some of these embodiments, the first location is a first fixed location, and the second location is a second fixed location, as perceived by the user. In some embodiments, the three-dimensional location of the nodal point of the eye for the user is determined based at least in part upon the set of world coordinates for the second target and the first set of pixel coordinates for the first target.

Some embodiments are directed to a method or process that spatially registers a set of targets comprising at least the first target and the second target in a display portion of a user interface of the extended-reality device, triggers an execution of a device fit process in response to receiving a device fit check signal sent by the extended-reality device, and adjusts a relative position of the extended-reality device to the user based at least in part upon a result of the device fit process.

Some embodiments are directed at a hardware system that may be invoked to perform any of the methods, processes, or sub-processes disclosed herein. The hardware system may include or involve an extended-reality system having at least one processor or at least one processor core, which executes one or more threads of execution to perform any of the methods, processes, or sub-processes disclosed herein in some embodiments. The hardware system may further include one or more forms of non-transitory machine-readable storage media or devices to temporarily or persistently store various types of data or information. Some exemplary modules or components of the hardware system may be found in the System Architecture Overview section below.

Some embodiments are directed at an article of manufacture that includes a non-transitory machine-accessible storage medium having stored thereupon a sequence of instructions which, when executed by at least one processor or at least one processor core, causes the at least one processor or the at least one processor core to perform any of the methods, processes, or sub-processes disclosed herein. Some exemplary forms of the non-transitory machine-readable storage media may also be found in the System Architecture Overview section below.

### SUMMARY RECITATION OF SOME EMBODIMENTS OF THE DISCLOSURE

1. A computer implemented method, comprising: presenting a first target at a first location and a second target at a second location to a user using an extended-reality (XR) device, wherein the first target is perceived as closer to the user than the second target is perceived; aligning the first target and the second target to each other at least by performing an alignment process that moves the first target or the second target presented to the user; and determining a nodal point for an eye of the user based at least in part upon the first and the second target.

2. The computer implemented method of embodiment 1, determining the nodal point for the eye of the user comprising: determining a first line connecting the first target and the second target; and determining the nodal point for the eye along the line based at least in part upon a first depth pertaining to the first target or a second depth pertaining to the second target.

3. The computer implemented method of embodiment 2, determining the nodal point for the eye of the user further comprising: presenting a third target at a third location and a fourth target at a fourth location to the user, wherein the third target is perceived as closer to the user than the fourth target is perceived; and determining a second line connecting the third and the fourth target.

4. The computer implemented method of embodiment 3, determining the nodal point for the eye of the user further comprising: determining the nodal point for the eye based at least in part upon the first line and the second line; and provisioning one or more virtual input modules to user or the authorized user for the management software application.

5. The computer implemented method of embodiment 1, aligning the first target and the second target to each other further comprising: identifying a pixel coordinate system for the XR device; presenting the first target at a fixed location in the pixel coordinate system to the user using the XR device; and presenting the second target at a moveable location to the user using the XR device, the fixed location being closer to the user than the moveable location.

6. The computer implemented method of embodiment 5, aligning the first target and the second target to each other further comprising: aligning the first target to the second target as perceived by the user by adjusting the moveable location to an adjusted location; and determining a three-dimensional (3D) location of the nodal point of the eye for the user based at least in part on the first fixed location and the adjusted location.

7. The computer implemented method of embodiment 1, aligning the first target and the second target to each other further comprising: identifying a pixel coordinate system for the XR device; presenting the first target at a moveable location to the user using the XR device; and presenting the second target at a fixed location in the pixel coordinate system to the user using the XR device, the moveable location being closer to the user than the fixed location.

8. The computer implemented method of embodiment 7, aligning the first target and the second target to each other further comprising: aligning the first target to the second target as perceived by the user by adjusting the moveable location to an adjusted location; and determining a three-dimensional (3D) location of the nodal point of the eye for the user based at least in part on the fixed location and the adjusted location.

9. The computer implemented method of embodiment 1, aligning the first target and the second target to each other further comprising: identifying a pixel coordinate system and a world coordinate system for the XR device; presenting the first target at a first fixed location in the pixel coordinate system to the user using the XR device; and presenting the second target at a second fixed location in the world coordinate system to the user using the XR device, the first fixed location being closer to the user than the second fixed location.

10. The computer implemented method of embodiment 9, aligning the first target and the second target to each other further comprising: aligning the first target to the second target as perceived by the user; and determining a three-dimensional (3D) location of the nodal point of the eye for the user based at least in part on the first fixed location, the second fixed location, and a result of aligning the first target to the second target.

11. The computer implemented method of embodiment 1, aligning the first target and the second target to each other further comprising: identifying a pixel coordinate system and a world coordinate system for the XR device; presenting the first target at a first fixed location in the world coordinate system to the user using the XR device; and presenting the second target at a second fixed location in the pixel coordinate system to the user using the XR device, the first fixed location being closer to the user than the second fixed location.

12. The computer implemented method of embodiment 11, aligning the first target and the second target to each other further comprising: aligning the first target to the second target as perceived by the user; and determining a three-dimensional (3D) location of the nodal point of the eye for the user based at least in part on the first fixed location, the second fixed location, and a result of aligning the first target to the second target.

13. A system, comprising: an extended-reality (XR) device comprising: a processor; and non-transitory machine-readable medium having stored thereupon a sequence of instructions which, when executed by the processor, causes the processor to execute a set of acts, the set of acts comprising: presenting a first target at a first location and a second target at a second location to a user using an extended-reality (XR) device, wherein the first target is perceived as closer to the user than the second target is perceived; aligning the first target and the second target to each other at least by performing an alignment process that moves the first target or the second target presented to the user; and determining a nodal point for an eye of the user based at least in part upon the first and the second target.

14. The system of embodiment 13, wherein the non-transitory machine-readable medium having stored thereupon the sequence of instructions which, when executed by the processor, causes the processor to execute the set of acts, the set of acts further comprising: determining a first line connecting the first target and the second target; and determining the nodal point for the eye along the line based at least in part upon a first depth pertaining to the first target or a second depth pertaining to the second target.

15. The system of embodiment 14, wherein the non-transitory machine-readable medium having stored thereupon the sequence of instructions which, when executed by the processor, causes the processor to execute the set of acts, the set of acts further comprising: presenting a third target at a third location and a fourth target at a fourth location to the user, wherein the third target is perceived as closer to the user than the fourth target is perceived; and determining a second line connecting the third and the fourth target.

16. The system of embodiment 15, wherein the non-transitory machine-readable medium having stored thereupon the sequence of instructions which, when executed by the processor, causes the processor to execute the set of acts, the set of acts further comprising: determining the nodal point for the eye based at least in part upon the first line and the second line; and provisioning one or more virtual input modules to user or the authorized user for the management software application.

17. The system of embodiment 13, wherein the non-transitory machine-readable medium having stored thereupon the sequence of instructions which, when executed by the processor, causes the processor to execute the set of acts, the set of acts further comprising: identifying a pixel coordinate system for the XR device; presenting the first target at a fixed location in the pixel coordinate system to the user using the XR device; and presenting the second target at a moveable location to the user using the XR device, the fixed location being closer to the user than the moveable location.

18. The system of embodiment 17, wherein the non-transitory machine-readable medium having stored thereupon the sequence of instructions which, when executed by the processor, causes the processor to execute the set of acts, the set of acts further comprising: aligning the first target to the second target as perceived by the user by adjusting the moveable location to an adjusted location; and determining a three-dimensional (3D) location of the nodal point of the eye for the user based at least in part on the first fixed location and the adjusted location.

19. The system of embodiment 13, wherein the non-transitory machine-readable medium having stored thereupon the sequence of instructions which, when executed by the processor, causes the processor to execute the set of acts, the set of acts further comprising: identifying a pixel coordinate system for the XR device; presenting the first target at a moveable location to the user using the XR device; and presenting the second target at a fixed location in the pixel coordinate system to the user using the XR device, the moveable location being closer to the user than the fixed location.

20. The system of embodiment 19, wherein the non-transitory machine-readable medium having stored thereupon the sequence of instructions which, when executed by the processor, causes the processor to execute the set of acts, the set of acts further comprising: aligning the first target to the second target as perceived by the user by adjusting the moveable location to an adjusted location; and determining a three-dimensional (3D) location of the nodal point of the eye for the user based at least in part on the fixed location and the adjusted location.

21. The system of embodiment 13, wherein the non-transitory machine-readable medium having stored thereupon the sequence of instructions which, when executed by the processor, causes the processor to execute the set of acts, the set of acts further comprising: identifying a pixel coordinate system and a world coordinate system for the XR device; presenting the first target at a first fixed location in the pixel coordinate system to the user using the XR device; and presenting the second target at a second fixed location in the world coordinate system to the user using the XR device, the first fixed location being closer to the user than the second fixed location.

22. The system of embodiment 21, wherein the non-transitory machine-readable medium having stored thereupon the sequence of instructions which, when executed by the processor, causes the processor to execute the set of acts, the set of acts further comprising: aligning the first target to the second target as perceived by the user; and determining a three-dimensional (3D) location of the nodal point of the eye for the user based at least in part on the first fixed location, the second fixed location, and a result of aligning the first target to the second target.

23. The system of embodiment 13, wherein the non-transitory machine-readable medium having stored thereupon the sequence of instructions which, when executed by the processor, causes the processor to execute the set of acts, the set of acts further comprising: identifying a pixel coordinate system and a world coordinate system for the XR device; presenting the first target at a first fixed location in the world coordinate system to the user using the XR device; and presenting the second target at a second fixed location in the pixel coordinate system to the user using the XR device, the first fixed location being closer to the user than the second fixed location.

24. The system of embodiment 23, wherein the non-transitory machine-readable medium having stored thereupon the sequence of instructions which, when executed by the processor, causes the processor to execute the set of acts, the set of acts further comprising: aligning the first target to the second target as perceived by the user; and determining a three-dimensional (3D) location of the nodal point of the eye for the user based at least in part on the first fixed location, the second fixed location, and a result of aligning the first target to the second target.

25. A computer program product comprising a non-transitory computer readable storage medium having stored thereupon a sequence of instructions which, when executed by a processor, causes the processor to execute a set of acts, the set of acts comprising: presenting a first target at a first location and a second target at a second location to a user using an extended-reality (XR) device, wherein the first target is perceived as closer to the user than the second target is perceived; aligning the first target and the second target to each other at least by performing an alignment process that moves the first target or the second target presented to the user; and determining a nodal point for an eye of the user based at least in part upon the first and the second target.

26. The computer program product of embodiment 25, wherein the non-transitory machine-readable medium having stored thereupon the sequence of instructions which, when executed by the processor, causes the processor to execute the set of acts, the set of acts further comprising: determining a first line connecting the first target and the second target; and determining the nodal point for the eye along the line based at least in part upon a first depth pertaining to the first target or a second depth pertaining to the second target.

27. The system of embodiment 26, wherein the non-transitory machine-readable medium having stored thereupon the sequence of instructions which, when executed by the processor, causes the processor to execute the set of acts, the set of acts further comprising: presenting a third target at a third location and a fourth target at a fourth location to the user, wherein the third target is perceived as closer to the user than the fourth target is perceived; an determining a second line connecting the third and the fourth target.

28. The computer program product of embodiment 27, wherein the non-transitory machine-readable medium having stored thereupon the sequence of instructions which, when executed by the processor, causes the processor to execute the set of acts, the set of acts further comprising: determining the nodal point for the eye based at least in part upon the first line and the second line; and provisioning one or more virtual input modules to user or the authorized user for the management software application.

29. The computer program product of embodiment 26, wherein the non-transitory machine-readable medium having stored thereupon the sequence of instructions which, when executed by the processor, causes the processor to execute the set of acts, the set of acts further comprising: identifying a pixel coordinate system for the XR device; presenting the first target at a fixed location in the pixel coordinate system to the user using the XR device; and presenting the second target at a moveable location to the user using the XR device, the fixed location being closer to the user than the moveable location.

30. The computer program product of embodiment 29, wherein the non-transitory machine-readable medium having stored thereupon the sequence of instructions which, when executed by the processor, causes the processor to execute the set of acts, the set of acts further comprising: aligning the first target to the second target as perceived by the user by adjusting the moveable location to an adjusted location; and determining a three-dimensional (3D) location of the nodal point of the eye for the user based at least in part on the first fixed location and the adjusted location.

31. The computer program product of embodiment 25, wherein the non-transitory machine-readable medium having stored thereupon the sequence of instructions which, when executed by the processor, causes the processor to execute the set of acts, the set of acts further comprising: identifying a pixel coordinate system for the XR device; presenting the first target at a moveable location to the user using the XR device; and presenting the second target at a fixed location in the pixel coordinate system to the user using the XR device, the moveable location being closer to the user than the fixed location.

32. The computer program product of embodiment 31, wherein the non-transitory machine-readable medium having stored thereupon the sequence of instructions which, when executed by the processor, causes the processor to execute the set of acts, the set of acts further comprising: aligning the first target to the second target as perceived by the user by adjusting the moveable location to an adjusted location; and determining a three-dimensional (3D) location of the nodal point of the eye for the user based at least in part on the fixed location and the adjusted location.

33. The computer program product of embodiment 25, wherein the non-transitory machine-readable medium having stored thereupon the sequence of instructions which, when executed by the processor, causes the processor to execute the set of acts, the set of acts further comprising: identifying a pixel coordinate system and a world coordinate system for the XR device; presenting the first target at a first fixed location in the pixel coordinate system to the user using the XR device; and presenting the second target at a second fixed location in the world coordinate system to the user using the XR device, the first fixed location being closer to the user than the second fixed location.

34. The computer program product of embodiment 33, wherein the non-transitory machine-readable medium having stored thereupon the sequence of instructions which, when executed by the processor, causes the processor to execute the set of acts, the set of acts further comprising: aligning the first target to the second target as perceived by the user; and determining a three-dimensional (3D) location of the nodal point of the eye for the user based at least in part on the first fixed location, the second fixed location, and a result of aligning the first target to the second target.

35. The computer program product of embodiment 25, wherein the non-transitory machine-readable medium having stored thereupon the sequence of instructions which, when executed by the processor, causes the processor to execute the set of acts, the set of acts further comprising: identifying a pixel coordinate system and a world coordinate system for the XR device; presenting the first target at a first fixed location in the world coordinate system to the user using the XR device; and presenting the second target at a second fixed location in the pixel coordinate system to the user using the XR device, the first fixed location being closer to the user than the second fixed location.

36. The computer program product of embodiment 35, wherein the non-transitory machine-readable medium having stored thereupon the sequence of instructions which, when executed by the processor, causes the processor to execute the set of acts, the set of acts further comprising: aligning the first target to the second target as perceived by the user; and determining a three-dimensional (3D) location of the nodal point of the eye for the user based at least in part on the first fixed location, the second fixed location, and a result of aligning the first target to the second target.

37. A system, comprising: an extended-reality (XR) device comprising: a processor; and non-transitory machine-readable medium having stored thereupon a sequence of instructions which, when executed by the processor, causes the processor to execute a set of acts, the set of acts comprising: spatially registering a set of targets in display portion of a user interface of the XR device comprising an adjustment mechanism that is used to adjust a relative position of the XR device to a user; triggering execution of a device fit process in response to receiving a device fit check signal; and adjusting a relative position of the XR device to the user based on the device fit process.

38. The system of embodiment 37, wherein the non-transitory machine-readable medium having stored thereupon the sequence of instructions which, when executed by the processor, causes the processor to execute the set of acts for triggering the execution of the device fit process, the set of acts further comprising: receiving a head pose signal indicating a head pose of a user wearing the XR device; determining whether the set of targets is within a field of view of the user based at least in part upon the head pose signal; and in response to determining that the set of targets is within the field of view of the user, receiving a gazing signal indicating a gaze direction of the user and determined based at least in part on one or more calculated gazing directions of one or both eyes of the user.

39. The system of embodiment 38, wherein the non-transitory machine-readable medium having stored thereupon the sequence of instructions which, when executed by the processor, causes the processor to execute the set of acts for triggering the execution of the device fit process, the set of acts further comprising: determining whether the user is gazing at the set of targets for over a threshold time period based at least in part upon the gazing signal; and in response to determining that the user is gazing at the set of targets over the threshold time period, triggering execution of a device fit check process.

40. The system of embodiment 38, wherein the non-transitory machine-readable medium having stored thereupon the sequence of instructions which, when executed by the processor, causes the processor to execute the set of acts for receiving the head pose signal, the set of acts further comprising: determining the head pose signal based at least in part upon position data and orientation data of the XR device; determining the position data using a world coordinate system; an determining the orientation data using a local coordinate system.

41. The system of embodiment 37, wherein the non-transitory machine-readable medium having stored thereupon the sequence of instructions which, when executed by the processor, causes the processor to execute the set of acts for the device fit process, the set of acts further comprising: presenting a first target in the set of targets at a first location to the user; presenting a second target in the set of targets at a second location to the user, the user perceiving the first target to be closer to the user than the second target; and transmitting a signal to the XR device to cause one or both pupils of the user to contract.

42. The system of embodiment 41, wherein the non-transitory machine-readable medium having stored thereupon the sequence of instructions which, when executed by the processor, causes the processor to execute the set of acts for transmitting the signal to the XR device to cause the one or both pupils of the user to contract, the set of acts further comprising: increasing brightness of display to one or both pupils of the user; or triggering a light source to illuminate at least the one or both pupils of the user.

43. The system of embodiment 41, wherein the non-transitory machine-readable medium having stored thereupon the sequence of instructions which, when executed by the processor, causes the processor to execute the set of acts for transmitting the signal to the XR device to cause the one or both pupils of the user to contract, the set of acts further comprising: aligning the first target and the second target to each other as perceived by the user at least by adjusting a relative position into an adjusted relative position of the XR device to the user with the adjustment mechanism; and calibrating an eye tracking model based at least the first location of the first target and the second location of the second target.

44. The system of embodiment 43, wherein the non-transitory machine-readable medium having stored thereupon the sequence of instructions which, when executed by the processor, causes the processor to execute the set of acts for calibrating the eye tracking model, the set of acts further comprising: identifying a predicted nodal point produced by the eye tracking model for the eye of the user; and determining a nodal point of the eye of the user based at least in part upon the first location of the first target and the second location of the second target.

45. The system of embodiment 44, wherein the non-transitory machine-readable medium having stored thereupon the sequence of instructions which, when executed by the processor, causes the processor to execute the set of acts for calibrating the eye tracking model, the set of acts further comprising: determining whether the predicted nodal point is within an eye-box for the eye when the XR device is adjusted to the adjusted relative position; and in response to determining that the predicted nodal point is within the eye-box for the eye, skipping calibration of the predicted nodal point.

46. The system of embodiment 45, wherein the non-transitory machine-readable medium having stored thereupon the sequence of instructions which, when executed by the processor, causes the processor to execute the set of acts for calibrating the eye tracking model, the set of acts further comprising: calibrating the nodal point and the predicted nodal point with respect to each other; and setting the nodal point as the predicted nodal point for the eye tracking model, determining an average or a weighted average point between the nodal point and the predicted nodal point based at least in part upon close proximity of the nodal point and the predicted nodal point to a nominal center of the eye-box.

47. A computer program product comprising a non-transitory computer readable storage medium having stored thereupon a sequence of instructions which, when executed by a processor, causes the processor to execute a set of acts, the set of acts comprising: presenting a first target at a first location and a second target at a second location to a user using an extended-reality (XR) device, wherein the first target is perceived as closer to the user than the second target is perceived; aligning the first target and the second target to each other at least by performing an alignment process that moves the first target or the second target presented to the user; and determining a nodal point for an eye of the user based at least in part upon the first and the second target.

48. The computer program product of embodiment 47, wherein the non-transitory machine-readable medium having stored thereupon the sequence of instructions which, when executed by the processor, causes the processor to execute the set of acts for triggering the execution of the device fit process, the set of acts further comprising: receiving a head pose signal indicating a head pose of a user wearing the XR device; determining whether the set of targets is within a field of view of the user based at least in part upon the head pose signal; and in response to determining that the set of targets is within the field of view of the user, receiving a gazing signal indicating a gaze direction of the user and determined based at least in part on one or more calculated gazing directions of one or both eyes of the user.

49. The computer program product of embodiment 48, wherein the non-transitory machine-readable medium having stored thereupon the sequence of instructions which, when executed by the processor, causes the processor to execute the set of acts for triggering the execution of the device fit process, the set of acts further comprising: determining whether the user is gazing at the set of targets for over a threshold time period based at least in part upon the gazing signal; and in response to determining that the user is gazing at the set of targets over the threshold time period, triggering execution of a device fit check process.

50. The computer program product of embodiment 48, wherein the non-transitory machine-readable medium having stored thereupon the sequence of instructions which, when executed by the processor, causes the processor to execute the set of acts for receiving the head pose signal, the set of acts further comprising: determining the head pose signal based at least in part upon position data and orientation data of the XR device; determining the position data using a world coordinate system; and determining the orientation data using a local coordinate system.

51. The computer program product of embodiment 47, wherein the non-transitory machine-readable medium having stored thereupon the sequence of instructions which, when executed by the processor, causes the processor to execute the set of acts for the device fit process, the set of acts further comprising: presenting a first target in the set of targets at a first location to the user; presenting a second target in the set of targets at a second location to the user, the user perceiving the first target to be closer to the user than the second target; and transmitting a signal to the XR device to cause one or both pupils of the user to contract.

52. The computer program product of embodiment 51, wherein the non-transitory machine-readable medium having stored thereupon the sequence of instructions which, when executed by the processor, causes the processor to execute the set of acts for transmitting the signal to the XR device to cause the one or both pupils of the user to contract, the set of acts further comprising: increasing brightness of display to one or both pupils of the user; or triggering a light source to illuminate at least the one or both pupils of the user.

53. The computer program product of embodiment 51, wherein the non-transitory machine-readable medium having stored thereupon the sequence of instructions which, when executed by the processor, causes the processor to execute the set of acts for transmitting the signal to the XR device to cause the one or both pupils of the user to contract, the set of acts further comprising: aligning the first target and the second target to each other as perceived by the user at least by adjusting a relative position into an adjusted relative position of the XR device to the user with the adjustment mechanism; and calibrating an eye tracking model based at least the first location of the first target and the second location of the second target.

54. The computer program product of embodiment 53, wherein the non-transitory machine-readable medium having stored thereupon the sequence of instructions which, when executed by the processor, causes the processor to execute the set of acts for calibrating the eye tracking model, the set of acts further comprising: identifying a predicted nodal point produced by the eye tracking model for the eye of the user; and determining a nodal point of the eye of the user based at least in part upon the first location of the first target and the second location of the second target.

55. The computer program product of embodiment 54, wherein the non-transitory machine-readable medium having stored thereupon the sequence of instructions which, when executed by the processor, causes the processor to execute the set of acts for calibrating the eye tracking model, the set of acts further comprising: determining whether the predicted nodal point is within an eye-box for the eye when the XR device is adjusted to the adjusted relative position; and in response to determining that the predicted nodal point is within the eye-box for the eye, skipping calibration of the predicted nodal point.

56. The computer program product of embodiment 55, wherein the non-transitory machine-readable medium having stored thereupon the sequence of instructions which, when executed by the processor, causes the processor to execute the set of acts for calibrating the eye tracking model, the set of acts further comprising: calibrating the nodal point and the predicted nodal point with respect to each other; and setting the nodal point as the predicted nodal point for the eye tracking model, determining an average or a weighted average point between the nodal point and the predicted nodal point based at least in part upon close proximity of the nodal point and the predicted nodal point to a nominal center of the eye-box.

57. A method, comprising: presenting a first target at a first location and a second target at a second location to a user using an extended-reality (XR) device, wherein the first target is perceived as closer to the user than the second target is perceived; aligning the first target and the second target to each other at least by performing an alignment process that moves the first target or the second target presented to the user; and determining a nodal point for an eye of the user based at least in part upon the first and the second target.

58. The method of embodiment 57, triggering the execution of the device fit process comprising: receiving a head pose signal indicating a head pose of a user wearing the XR device; determining whether the set of targets is within a field of view of the user based at least in part upon the head pose signal; and in response to determining that the set of targets is within the field of view of the user, receiving a gazing signal indicating a gaze direction of the user and determined based at least in part on one or more calculated gazing directions of one or both eyes of the user.

59. The method of embodiment 58, triggering the execution of the device fit process further comprising: determining whether the user is gazing at the set of targets for over a threshold time period based at least in part upon the gazing signal; and in response to determining that the user is gazing at the set of targets over the threshold time period, triggering execution of a device fit check process.

60. The method of embodiment 58, receiving the head pose signal comprising: determining the head pose signal based at least in part upon position data and orientation data of the XR device; determining the position data using a world coordinate system; an determining the orientation data using a local coordinate system.

61. The method of embodiment 57, the device fit process comprising: presenting a first target in the set of targets at a first location to the user; presenting a second target in the set of targets at a second location to the user, the user perceiving the first target to be closer to the user than the second target; and transmitting a signal to the XR device to cause one or both pupils of the user to contract.

62. The method of embodiment 61, transmitting the signal to the XR device comprising increasing brightness of display to one or both pupils of the user; or triggering a light source to illuminate at least the one or both pupils of the user.

63. The method of embodiment 61, transmitting the signal to the XR device further comprising: aligning the first target and the second target to each other as perceived by the user at least by adjusting a relative position into an adjusted relative position of the XR device to the user with the adjustment mechanism; and calibrating an eye tracking model based at least the first location of the first target and the second location of the second target.

64. The method of embodiment 63, calibrating the eye tracking model comprising: identifying a predicted nodal point produced by the eye tracking model for the eye of the user; and determining a nodal point of the eye of the user based at least in part upon the first location of the first target and the second location of the second target.

65. The method of embodiment 64, calibrating the eye tracking model further comprising: determining whether the predicted nodal point is within an eye-box for the eye when the XR device is adjusted to the adjusted relative position; and in response to determining that the predicted nodal point is within the eye-box for the eye, skipping calibration of the predicted nodal point.

66. The method of embodiment 65, calibrating the eye tracking model further comprising: calibrating the nodal point and the predicted nodal point with respect to each other; and setting the nodal point as the predicted nodal point for the eye tracking model, determining an average or a weighted average point between the nodal point and the predicted nodal point based at least in part upon close proximity of the nodal point and the predicted nodal point to a nominal center of the eye-box.

67. A machine implemented method, comprising: determining a pose for an eye of a user wearing a wearable display device based at least in part upon a pattern on a side of a frustum of a sighting device; determining a virtual render camera position for wearable display device with respect to the eye of the user based at least in part upon the pose; placing a virtual render camera at the virtual render camera position for the eye of the user; and projecting light beams representing virtual contents into the eye of the user based at least in part upon the virtual render camera position.

68. The machine implemented method of embodiment 67, further comprising: determining whether to compromise the virtual camera position based at least in part upon one or more criteria, wherein the one or more criteria comprise at least one of an accuracy criterion, a relaxed accuracy criterion, a quick alignment criterion, or a sliding scale between two of the accuracy criterion, the quick alignment criterion, and the relaxed accuracy criterion.

69. The machine implemented method of embodiment 67, further comprising: activating a plurality of light sources, wherein each light source of the plurality of light sources corresponds to and is located at a first end of a channel in the frustum, and the frustum comprises a plurality of channels that respectively corresponds to the plurality of light sources.

70. The machine implemented method of embodiment 69, further comprising: capturing one or more first images of at least a portion of the frustum using an image capturing device or sensor, wherein the at least the portion of the frustum comprises a pattern or marker; and determining one or more first characteristics of the pattern or marker, wherein the one or more first characteristics of the pattern or marker comprise a first geometric characteristic of a feature in the pattern or marker.

71. The machine implemented method of embodiment 70, further comprising: adjusting a position or a relative position of the wearable display device, wherein the one or more first images are captured prior to adjusting the position or the relative position of the wearable display device.

72. The machine implemented method of embodiment 71, further comprising: receiving, at the wearable display device or a computing device connected to the wearable display device, a first signal, wherein the first signal indicates that the eye has perceived at least one light source of the plurality of light sources through a corresponding channel, the at least one light source and the eye are located at two different ends of the corresponding channel, and the first geometric characteristic is captured prior to adjusting the position or the relative position for the feature.

73. The machine implemented method of embodiment 72, further comprising: upon or after receiving the first signal at the wearable display device or the computing device, capturing one or more second images of at least the portion of the frustum using the image capturing device or sensor, wherein the at least the portion of the frustum comprises a pattern or marker; and determining one or more second characteristics of the pattern or marker, wherein the one or more second characteristics of the pattern or marker comprise a second geometric characteristic of the feature in the pattern or marker, and the second geometric characteristic is captured after adjusting the position or the relative position for the feature.

74. The machine implemented method of embodiment 73, further comprising: correlating the one or more first images with the one or more second images into a correlated dataset for one or more pairs of correlated images based at least in part upon the first geometric characteristic captured prior to adjusting the position or the relative position for the feature and the second geometric characteristic captured after adjusting the position or the relative position for the feature; and determining a change between the one or more first images and the one or more second images based at least in part upon the correlated dataset.

75. The machine implemented method of embodiment 73, further comprising: determining the virtual camera position based at least in part upon the one or more first images or the one or more second images.

76. The machine implemented method of embodiment 74, further comprising: determining the virtual camera position based at least in part upon the change between the one or more first images and the one or more second images.

77. The machine implemented method of embodiment 69, further comprising: intermittently deactivating one or more light sources of the plurality of light sources at one or more time points; promoting the user with instructions to trigger the first signal or a second signal when the user has perceives that the one or more light sources are deactivated; and upon receiving the first signal for a second time or the second signal, correlating the first signal for the second time or the second signal with the at least one of the one or more time points.

78. The machine implemented method of embodiment 77, further comprising: validating whether the eye of the user has perceived the plurality of light sources based at least in part upon the first signal received at a first time indicating that the eye of the user has perceived the plurality of light sources and information pertaining to the one or more time points at which the one or more light sources are deactivated.

79. A system, comprising a wearable display device that further comprises: an extended-reality (XR) device comprising: a microprocessor; and a non-transitory machine-readable medium having stored thereupon a sequence of instructions which, when executed by the processor, causes the processor to execute a set of acts, the set of acts comprising: determining a pose for an eye of a user wearing a wearable display device based at least in part upon a pattern on a side of a frustum of a sighting device; determining a virtual render camera position for wearable display device with respect to the eye of the user based at least in part upon the pose; placing a virtual render camera at the virtual render camera position for the eye of the user; and projecting light beams representing virtual contents into the eye of the user based at least in part upon the virtual render camera position.

80. The system of embodiment 79, wherein the non-transitory machine-readable medium having stored thereupon the sequence of instructions which, when executed by the processor, causes the processor to execute the set of acts, the set of acts further comprising: determining whether to compromise the virtual camera position based at least in part upon one or more criteria, wherein the one or more criteria comprise at least one of an accuracy criterion, a relaxed accuracy criterion, a quick alignment criterion, or a sliding scale between two of the accuracy criterion, the quick alignment criterion, and the relaxed accuracy criterion.

81. The system of embodiment 79, wherein the non-transitory machine-readable medium having stored thereupon the sequence of instructions which, when executed by the processor, causes the processor to execute the set of acts, the set of acts further comprising: activating a plurality of light sources, wherein each light source of the plurality of light sources corresponds to and is located at a first end of a channel in the frustum, and the frustum comprises a plurality of channels that respectively corresponds to the plurality of light sources.

82. The system of embodiment 72, wherein the non-transitory machine-readable medium having stored thereupon the sequence of instructions which, when executed by the processor, causes the processor to execute the set of acts, the set of acts further comprising: capturing one or more first images of at least a portion of the frustum using an image capturing device or sensor, wherein the at least the portion of the frustum comprises a pattern or marker; and determining one or more first characteristics of the pattern or marker, wherein the one or more first characteristics of the pattern or marker comprise a first geometric characteristic of a feature in the pattern or marker.

83. The system of embodiment 82, wherein the non-transitory machine-readable medium having stored thereupon the sequence of instructions which, when executed by the processor, causes the processor to execute the set of acts, the set of acts further comprising: adjusting a position or a relative position of the wearable display device, wherein the one or more first images are captured prior to adjusting the position or the relative position of the wearable display device.

84. The system of embodiment 83, wherein the non-transitory machine-readable medium having stored thereupon the sequence of instructions which, when executed by the processor, causes the processor to execute the set of acts, the set of acts further comprising: receiving, at the wearable display device or a computing device connected to the wearable display device, a first signal, wherein the first signal indicates that the eye has perceived at least one light source of the plurality of light sources through a corresponding channel, the at least one light source and the eye are located at two different ends of the corresponding channel, and the first geometric characteristic is captured prior to adjusting the position or the relative position for the feature.

85. The system of embodiment 84, wherein the non-transitory machine-readable medium having stored thereupon the sequence of instructions which, when executed by the processor, causes the processor to execute the set of acts, the set of acts further comprising: capturing one or more second images of at least the portion of the frustum using the image capturing device or sensor, wherein the at least the portion of the frustum comprises a pattern or marker; and determining one or more second characteristics of the pattern or marker, wherein the one or more second characteristics of the pattern or marker comprise a second geometric characteristic of the feature in the pattern or marker, and the second geometric characteristic is captured after adjusting the position or the relative position for the feature.

86. The system of embodiment 85, wherein the non-transitory machine-readable medium having stored thereupon the sequence of instructions which, when executed by the processor, causes the processor to execute the set of acts, the set of acts further comprising: correlating the one or more first images with the one or more second images into a correlated dataset for one or more pairs of correlated images based at least in part upon the first geometric characteristic captured prior to adjusting the position or the relative position for the feature and the second geometric characteristic captured after adjusting the position or the relative position for the feature; and determining a change between the one or more first images and the one or more second images based at least in part upon the correlated dataset.

87. The system of embodiment 85, wherein the non-transitory machine-readable medium having stored thereupon the sequence of instructions which, when executed by the processor, causes the processor to execute the set of acts, the set of acts further comprising: determining the virtual camera position based at least in part upon the one or more first images or the one or more second images.

88. The system of embodiment 86, wherein the non-transitory machine-readable medium having stored thereupon the sequence of instructions which, when executed by the processor, causes the processor to execute the set of acts, the set of acts further comprising: determining the virtual camera position based at least in part upon the change between the one or more first images and the one or more second images.

89. The system of embodiment 81, wherein the non-transitory machine-readable medium having stored thereupon the sequence of instructions which, when executed by the processor, causes the processor to execute the set of acts, the set of acts further comprising: intermittently deactivating one or more light sources of the plurality of light sources at one or more time points; promoting the user with instructions to trigger the first signal or a second signal when the user has perceives that the one or more light sources are deactivated; and upon receiving the first signal for a second time or the second signal, correlating the first signal for the second time or the second signal with the at least one of the one or more time points.

90. The system of embodiment 89, wherein the non-transitory machine-readable medium having stored thereupon the sequence of instructions which, when executed by the processor, causes the processor to execute the set of acts, the set of acts further comprising: validating whether the eye of the user has perceived the plurality of light sources based at least in part upon the first signal received at a first time indicating that the eye of the user has perceived the plurality of light sources and information pertaining to the one or more time points at which the one or more light sources are deactivated.

91. A computer program product comprising a non-transitory computer readable storage medium having stored thereupon a sequence of instructions which, when executed by a processor, causes the processor to execute a set of acts, the set of acts comprising: determining a pose for an eye of a user wearing a wearable display device based at least in part upon a pattern on a side of a frustum of a sighting device; determining a virtual render camera position for wearable display device with respect to the eye of the user based at least in part upon the pose; placing a virtual render camera at the virtual render camera position for the eye of the user; and projecting light beams representing virtual contents into the eye of the user based at least in part upon the virtual render camera position.

91. The computer program product of embodiment 90, wherein the non-transitory machine-readable medium having stored thereupon the sequence of instructions which, when executed by the processor, causes the processor to execute the set of acts, the set of acts further comprising: determining whether to compromise the virtual camera position based at least in part upon one or more criteria, wherein the one or more criteria comprise at least one of an accuracy criterion, a relaxed accuracy criterion, a quick alignment criterion, or a sliding scale between two of the accuracy criterion, the quick alignment criterion, and the relaxed accuracy criterion.

92. The computer program product of embodiment 90, wherein the non-transitory machine-readable medium having stored thereupon the sequence of instructions which, when executed by the processor, causes the processor to execute the set of acts, the set of acts further comprising: activating a plurality of light sources, wherein each light source of the plurality of light sources corresponds to and is located at a first end of a channel in the frustum, and the frustum comprises a plurality of channels that respectively corresponds to the plurality of light sources.

93. The computer program product of embodiment 92, wherein the non-transitory machine-readable medium having stored thereupon the sequence of instructions which, when executed by the processor, causes the processor to execute the set of acts, the set of acts further comprising: capturing one or more first images of at least a portion of the frustum using an image capturing device or sensor, wherein the at least the portion of the frustum comprises a pattern or marker; and determining one or more first characteristics of the pattern or marker, wherein the one or more first characteristics of the pattern or marker comprise a first geometric characteristic of a feature in the pattern or marker.

94. The computer program product of embodiment 93, wherein the non-transitory machine-readable medium having stored thereupon the sequence of instructions which, when executed by the processor, causes the processor to execute the set of acts, the set of acts further comprising: adjusting a position or a relative position of the wearable display device, wherein the one or more first images are captured prior to adjusting the position or the relative position of the wearable display device.

95. The computer program product of embodiment 94, wherein the non-transitory machine-readable medium having stored thereupon the sequence of instructions which, when executed by the processor, causes the processor to execute the set of acts, the set of acts further comprising: receiving, at the wearable display device or a computing device connected to the wearable display device, a first signal, wherein the first signal indicates that the eye has perceived at least one light source of the plurality of light sources through a corresponding channel, the at least one light source and the eye are located at two different ends of the corresponding channel, and the first geometric characteristic is captured prior to adjusting the position or the relative position for the feature.

96. The computer program product of embodiment 95, wherein the non-transitory machine-readable medium having stored thereupon the sequence of instructions which, when executed by the processor, causes the processor to execute the set of acts, the set of acts further comprising: upon or after receiving the first signal at the wearable display device or the computing device, capturing one or more second images of at least the portion of the frustum using the image capturing device or sensor, wherein the at least the portion of the frustum comprises a pattern or marker; and determining one or more second characteristics of the pattern or marker, wherein the one or more second characteristics of the pattern or marker comprise a second geometric characteristic of the feature in the pattern or marker, and the second geometric characteristic is captured after adjusting the position or the relative position for the feature.

97. The computer program product of embodiment 96, wherein the non-transitory machine-readable medium having stored thereupon the sequence of instructions which, when executed by the processor, causes the processor to execute the set of acts, the set of acts further comprising: correlating the one or more first images with the one or more second images into a correlated dataset for one or more pairs of correlated images based at least in part upon the first geometric characteristic captured prior to adjusting the position or the relative position for the feature and the second geometric characteristic captured after adjusting the position or the relative position for the feature; and determining a change between the one or more first images and the one or more second images based at least in part upon the correlated dataset.

98. The computer program product of embodiment 96, wherein the non-transitory machine-readable medium having stored thereupon the sequence of instructions which, when executed by the processor, causes the processor to execute the set of acts, the set of acts further comprising: determining the virtual camera position based at least in part upon the one or more first images or the one or more second images.

99. The computer program product of embodiment 97, wherein the non-transitory machine-readable medium having stored thereupon the sequence of instructions which, when executed by the processor, causes the processor to execute the set of acts, the set of acts further comprising: determining the virtual camera position based at least in part upon the change between the one or more first images and the one or more second images.

100. The computer program product of embodiment 92, wherein the non-transitory machine-readable medium having stored thereupon the sequence of instructions which, when executed by the processor, causes the processor to execute the set of acts, the set of acts further comprising: intermittently deactivating one or more light sources of the plurality of light sources at one or more time points; promoting the user with instructions to trigger the first signal or a second signal when the user has perceives that the one or more light sources are deactivated; and upon receiving the first signal for a second time or the second signal, correlating the first signal for the second time or the second signal with the at least one of the one or more time points.

101. The computer program product of embodiment 100, wherein the non-transitory machine-readable medium having stored thereupon the sequence of instructions which, when executed by the processor, causes the processor to execute the set of acts, the set of acts further comprising: validating whether the eye of the user has perceived the plurality of light sources based at least in part upon the first signal received at a first time indicating that the eye of the user has perceived the plurality of light sources and information pertaining to the one or more time points at which the one or more light sources are deactivated.

### BRIEF DESCRIPTION OF THE DRAWINGS

This patent or application file contains at least one drawing executed in color. Copies of this patent or patent application publication with color drawings will be provided by the U.S. Patent and Trademark Office upon request and payment of the necessary fee.

The drawings illustrate the design and utility of various embodiments of the invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1A illustrates a simplified example of a wearable XR device with a belt pack external to the XR glasses in some embodiments.

FIGS. 1B-1C respectively illustrate a perspective and side view of an alternative example headset for selectively distributing a load to a wearer's head while securely registering the headset to the head according to some embodiments.

FIG. 1D illustrates simplified examples of presentation presented by an extended reality (XR) device and perceived by a user due to the alignment between the XR device and the user in one or more embodiments.

FIG. 1E illustrates a simplified schematic diagram illustrating two sets of targets that are properly aligned and presented to a user who perceives these two sets of targets via an XR device in some embodiments.

FIG. 1F illustrates another simplified monocular example of presenting two targets at two displays for aligning an XR device or for determining a nodal point of an eye.

FIG. 1G illustrates a simplified diagram of presenting two sets of targets to an eye of a user in a monocular alignment process in some embodiments.

FIG. 1H illustrates a portion of a simplified user interface for an alignment process in some embodiments.

FIG. 1I illustrates a first state of two targets in an alignment process in some embodiments.

FIG. 1J illustrates a second state of two targets in the alignment process in some embodiments.

FIG. 1K illustrates a third state of two targets in the alignment process in some embodiments.

FIG. 1L illustrates a fourth, aligned state of two targets in the alignment process in some embodiments.

FIG. 1M illustrates a simplified example of misaligned XR device relative to the user in some embodiments.

FIG. 1N illustrates a simplified example binocular alignment process in some embodiments.

FIG. 2A illustrates a high-level block diagram for a system or method for determining a nodal point of an eye with an alignment process in some embodiments.

FIG. 2B illustrates more details of a portion of the high-level block diagram illustrated in FIG. 2A.

FIG. 2C illustrates an example block diagram for a method or system for determining a nodal point of an eye with an alignment process in some embodiments.

FIG. 2D illustrates another example block diagram for a method or system for determining a nodal point of an eye with an alignment process in some embodiments.

FIG. 2E illustrates another example block diagram for a method or system for determining a nodal point of an eye with an alignment process in some embodiments.

FIG. 2F illustrates another example block diagram for a method or system for determining a nodal point of an eye with an alignment process in some embodiments.

FIG. 3A illustrates a high-level block diagram for a method or system for performing a device fit process for an XR device in some embodiments.

FIG. 3B illustrates more details about a portion of the high-level block diagram illustrated in FIG. 3A.

FIG. 3C illustrates more details about a portion of the high-level block diagram illustrated in FIG. 3A.

FIG. 3D illustrates an example block diagram for a device fit process that may be performed by a method or system illustrated in FIG. 3A in some embodiments.

FIG. 3E illustrates more details about a portion of the block diagram illustrated in FIG. 3D in some embodiments.

FIG. 4 illustrates an example schematic diagram illustrating data flow in an XR system configured to provide an experience of extended-reality (XR) contents interacting with a physical world, according to some embodiments.

FIG. 5A illustrates a user wearing an XR display system rendering XR content as the user moves through a physical world environment in some embodiments.

FIG. 5B illustrates a simplified example schematic of a viewing optics assembly and attendant components.

FIG. 6 illustrates the display system 42 in greater details in some embodiments.

FIGS. 7A-7B illustrate simplified examples of eye tracking in some embodiments.

FIG. 8 illustrates a simplified example of universe browser prisms in one or more embodiments.

FIG. 9 illustrates an example user physical environment and system architecture for managing and displaying productivity applications and/or resources in a three-dimensional virtual space with an extended-reality system or device in one or more embodiments.

FIG. 10 illustrates a computerized system on which the methods described herein may be implemented.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computer systems, server computers, and/or communications networks have not been shown or described in detail to avoid unnecessarily obscuring descriptions of the embodiments.

It shall be noted that, unless the context requires otherwise, throughout the specification and claims which follow, the word “comprise” and variations thereof, such as, “comprises” and “comprising” are to be construed in an open, inclusive sense, that is as “including, but not limited to.”

It shall be further noted that Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, various features, structures, or characteristics described herein may be readily combined in any suitable manner in one or more embodiments. Furthermore, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Various embodiments will now be described in detail with reference to the drawings, which are provided as illustrative examples of the invention so as to enable those skilled in the art to practice the invention. Notably, the figures and the examples below are not meant to limit the scope of the present invention. Where certain elements of the present invention may be partially or fully implemented using known components (or methods or processes), only those portions of such known components (or methods or processes) that are necessary for an understanding of the present invention will be described, and the detailed descriptions of other portions of such known components (or methods or processes) will be omitted so as not to obscure the invention. Various embodiments are directed to management of a virtual-reality (“VR”), augmented reality (“AR”), mixed-reality (“MR”), and/or extended reality (“XR”) system (collectively referred to as an “XR system” or extended-reality system) in various embodiments.

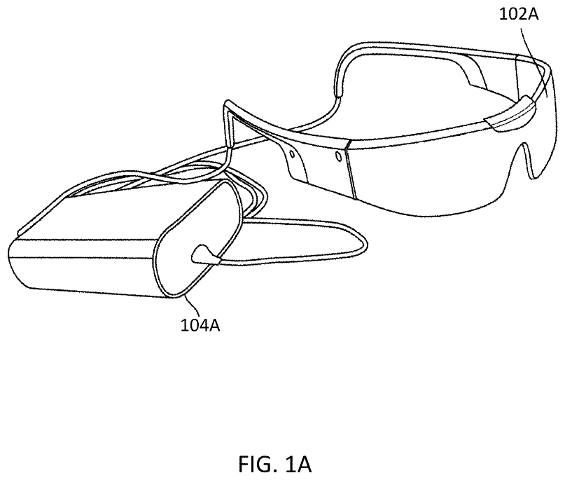

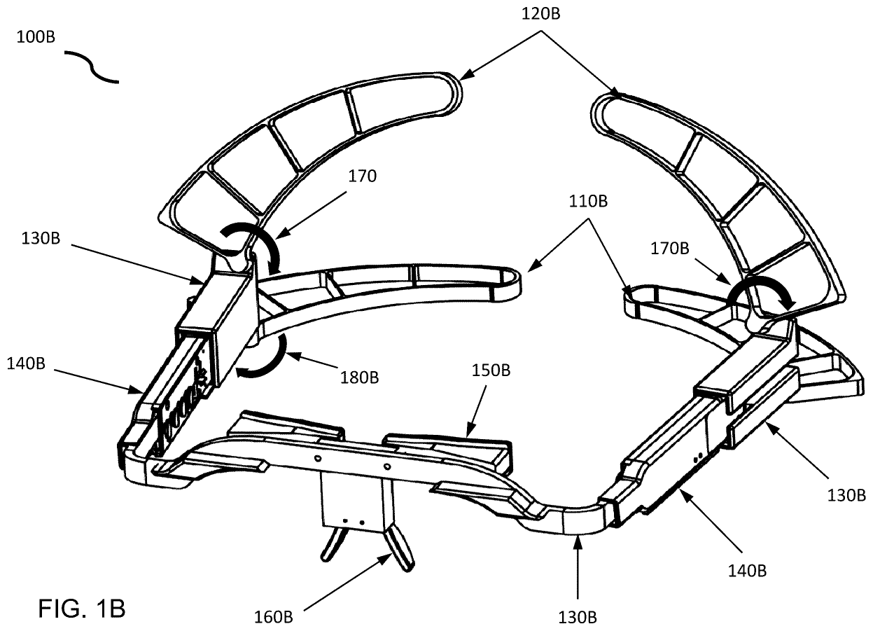

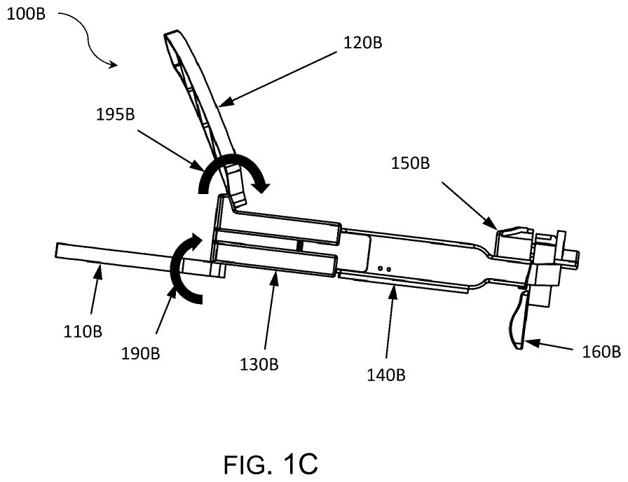

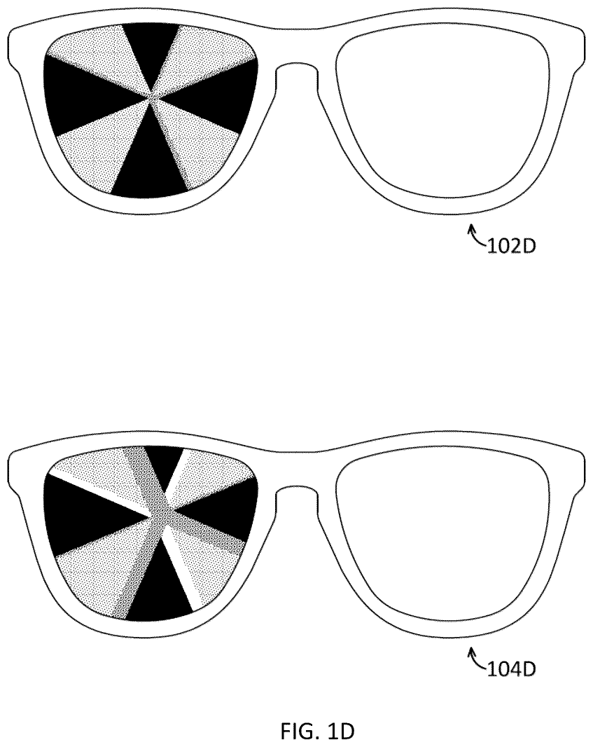

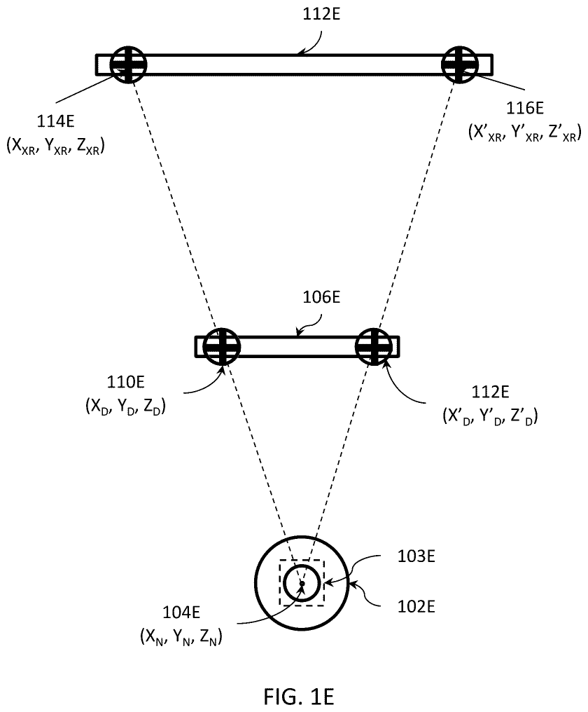

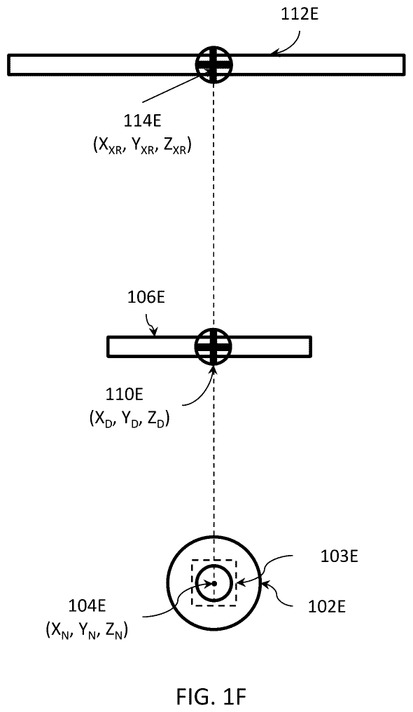

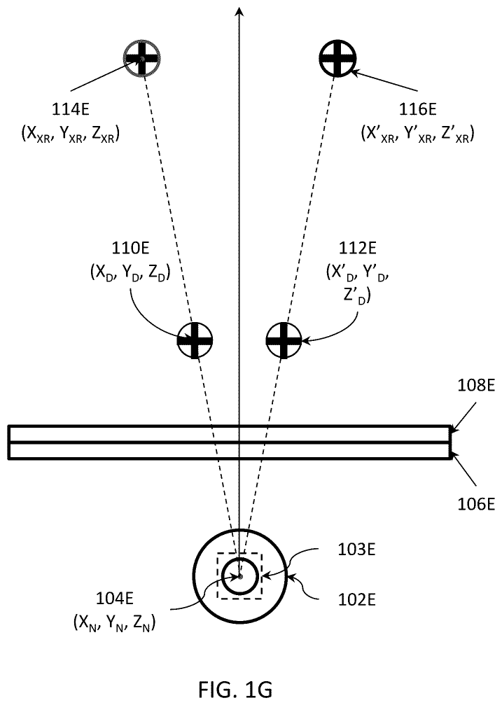

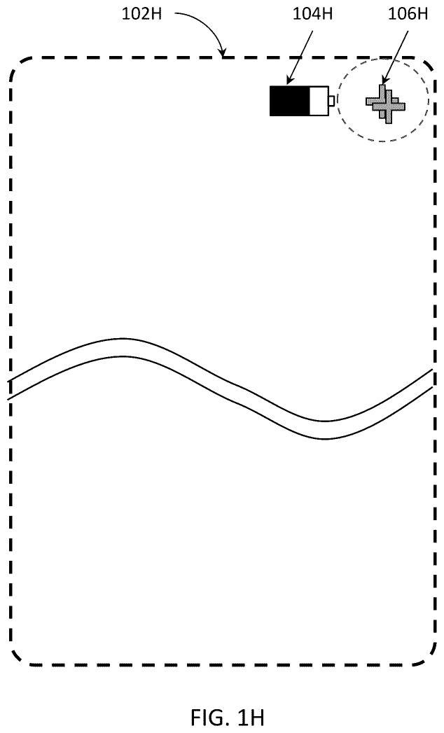

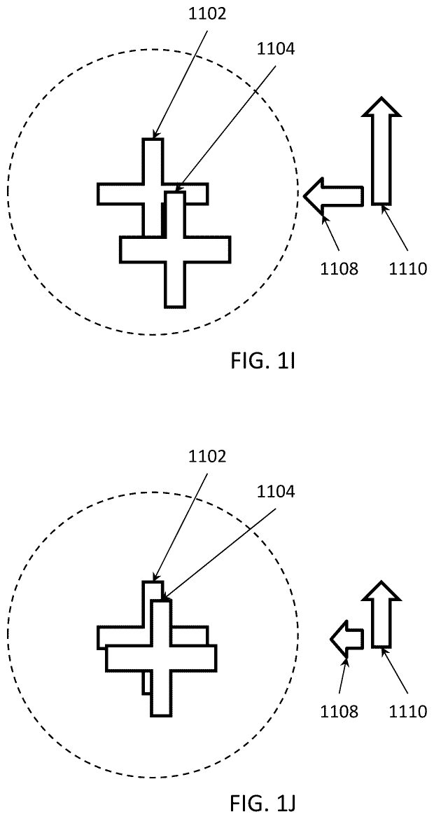

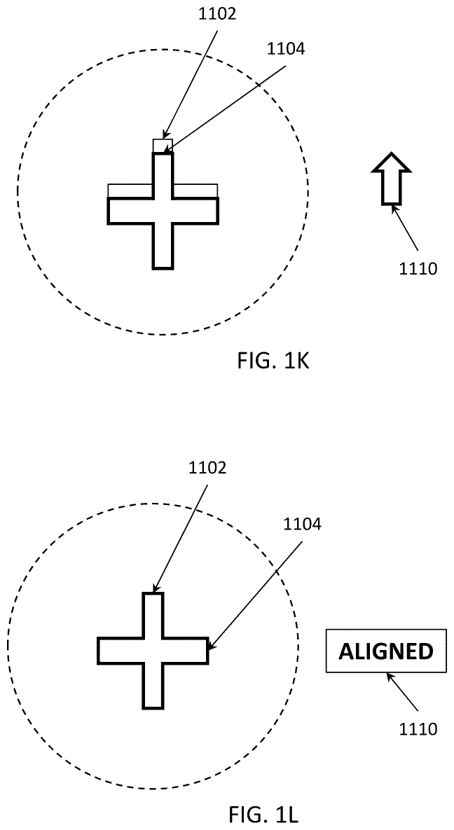

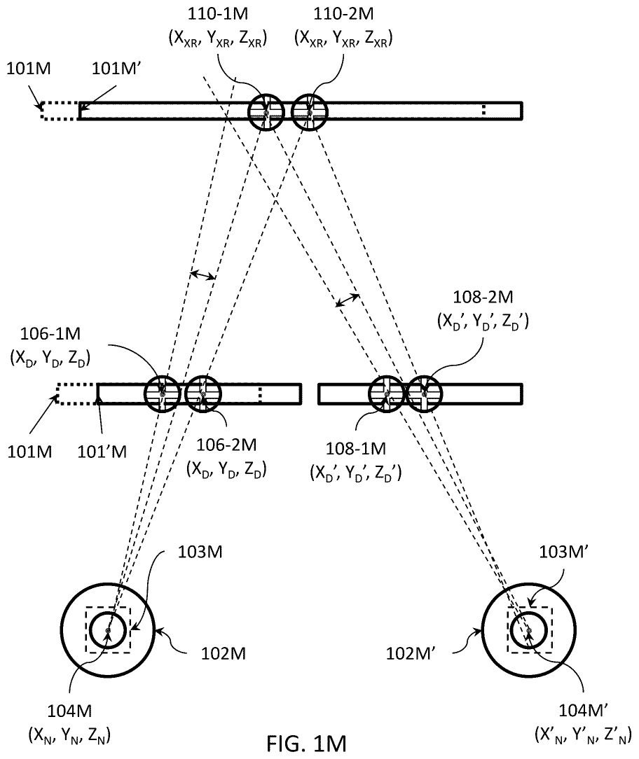

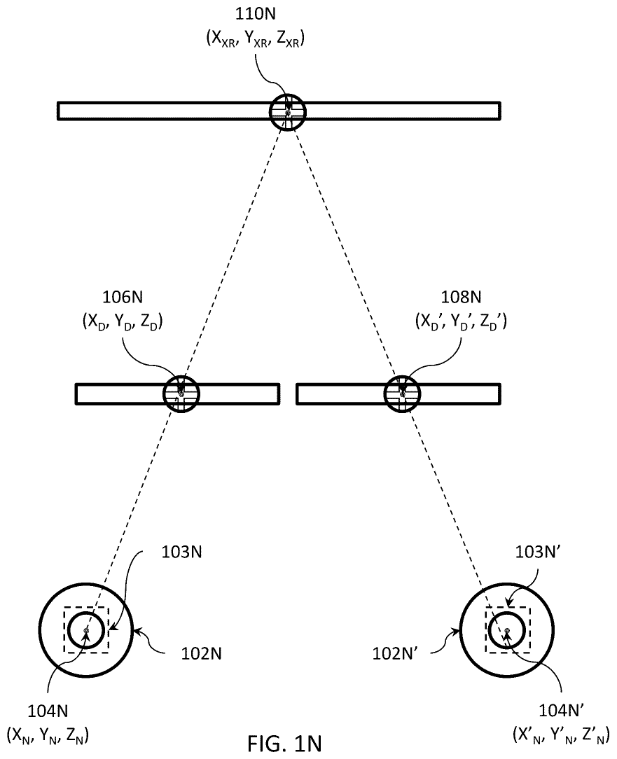

FIG. 1A illustrates a simplified example of a wearable XR device with a belt pack external to the XR glasses in some embodiments. More specifically, FIG. 1A illustrates a simplified example of a user-wearable VR/AR/MR/XR system that includes an optical sub-system 102A and a processing sub-system 104A and may include multiple instances of personal augmented reality systems, for example a respective personal augmented reality system for a user. Any of the neural networks described herein may be embedded in whole or in part in or on the wearable XR device. For example, some or all of a neural network described herein as well as other peripherals (e.g., ToF or time-of-flight sensors) may be embedded on the processing sub-system 104A alone, the optical sub-system 102A alone, or distributed between the processing sub-system 104A and the optical sub-system 102A.

Some embodiments of the VR/AR/MR/XR system may comprise optical sub-system 102E that deliver virtual content to the user's eyes as well as processing sub-system 104A that perform a multitude of processing tasks to present the relevant virtual content to a user. The processing sub-system 104A may, for example, take the form of the belt pack, which can be convenience coupled to a belt or belt line of pants during use. Alternatively, the processing sub-system 104A may, for example, take the form of a personal digital assistant or smartphone type device.

The processing sub-system 104A may include one or more processors, for example, one or more micro-controllers, microprocessors, graphical processing units, digital signal processors, application specific integrated circuits (ASICs), programmable gate arrays, programmable logic circuits, or other circuits either embodying logic or capable of executing logic embodied in instructions encoded in software or firmware. The processing sub-system 104A may include one or more non-transitory computer-or processor-readable media, for example volatile and/or nonvolatile memory, for instance read only memory (ROM), random access memory (RAM), static RAM, dynamic RAM, Flash memory, EEPROM, etc.

The processing sub-system 104A may be communicatively coupled to the head worn component. For example, the processing sub-system 104A may be communicatively tethered to the head worn component via one or more wires or optical fibers via a cable with appropriate connectors. The processing sub-system 102A and the optical sub-system 104A may communicate according to any of a variety of tethered protocols, for example UBS®, USB2®, USB3®, USB-C®, Ethernet®, Thunderbolt®, Lightning® protocols.

Alternatively or additionally, the processing sub-system 104A may be wirelessly communicatively coupled to the head worn component. For example, the processing sub-system 104A and the optical sub-system 102A may each include a transmitter, receiver or transceiver (collectively radio) and associated antenna to establish wireless communications there between. The radio and antenna(s) may take a variety of forms. For example, the radio may be capable of short-range communications, and may employ a communications protocol such as BLUETOOTH®, WI-FI®, or some IEEE 802.11 compliant protocol (e.g., IEEE 802.11n, IEEE 802.11a/c). Various other details of the processing sub-system and the optical sub-system are described in U.S. patent application Ser. No. 14/707,000 filed on May 8, 2015 and entitled “EYE TRACKING SYSTEMS AND METHOD FOR AUGMENTED OR EXTENDED-REALITY”, the content of which is hereby expressly incorporated by reference in its entirety for all purposes.

FIGS. 1B-1C respectively illustrate a perspective and side view of an alternative example headset for selectively distributing a load to a wearer's head while securely registering the headset to the head according to some embodiments.

As shown in FIGS. 1B-1C, headset 100B comprises upper compliant arms 120B. Upper compliant arms 120B are compliant mechanisms such as compliant arms 110B. Upper compliant arms 120B may provide additional selective distribution of the weight of the headset on a wearer's head. In some embodiments, headset 100B comprises one or more frame adapter 130B.

Frame adapter 130B is an adapter that couples the compliant arms to the frame 140B. In some embodiments, only the compliant arms 110B are coupled to a frame adapter 130B. In other embodiments, both the compliant arms 110B and the upper compliant arms 120B are coupled to the frame adapter 130B. In other embodiments, a compliant arm 110B and a plurality of upper compliant arms 120B are coupled to the frame adapter 130B. Yet in other embodiments, the compliant arm(s) and the frame adapter 130B may be constructed as a single piece/body. In the event the upper compliant arms 120B and/or the compliant arm 110B is coupled to the frame adapter 130BB, the compliant arms may be coupled to the frame adapter using different types of attachments such as, for example, bolt-on arms, snap on arms, rotatable snap-fit arms, ratcheting features, and an extendible arm-mount or central component to disclose just a few. One of ordinary skill in the art appreciates there may be other types of attachments to couple a compliant arm to the frame adapter 130B.

Frame adapter 130B may be rigidly attached onto the frame 140B using various techniques such as, for example, sliding or snapping the frame adapter 130B onto the temple arms of the frame 140B. In some embodiments, frame adapter 130B having the compliant arm(s) and the frame 140B may be a single piece. In other embodiments, frame adapter 130B may be adjustable along the frame 140B to allow varying head sizes and shapes of different wearers. One of ordinary skill in the art appreciates there are many other ways to attach the frame adapter 130B to the frame 140B.

Upper compliant arms 120B may be adjustable on a multi-axis (e.g., vertical plane and/or horizontal plane with respect to how the arm is coupled to the frame) when coupled to frame 140B or to frame adapter 130B. Upper compliant arms 120B may be adjustable along a variety of adjustable angle 170B along a horizontal plane (e.g., a plane relative to how the arm is coupled to the frame) to allow the upper compliant arms to contact a wearer's head at a particular angle which may be suitable for most head sizes and shapes or which may be required due to a particular deformation profile. The ability to adjust the upper compliant arms along adjustable angle 170B allows the wearer flexibility of setting an initial fit. The setting of the adjustable angle 170B for the initial fit may be by snapping the upper compliant arms 120B into place, spring-loaded detents, a screw in feature, other mechanism, or a secondary set of compliant mechanisms that adjusts the adjustable angle 170B of the upper compliant arms 120B. The compliant arms may also be displaced or distorted along the same vertical plane as adjustable angle 170B once the headset 100B is applied onto a wearer's head. In some embodiments, it is this displacement or distortion of force or weight along adjustable angle 170B that allows the compliant arm to selectively distribute a point load along its flexible structure to the wearer's head.

In some embodiments, upper compliant arms 120B may be adjustable on a multi-axis (e.g., vertical plane and/or horizontal plane with respect to how the arm is coupled to the frame) when coupled to frame 140 or frame adapter 130B. For example, upper compliant arms 120B may be adjustable along adjustable angle 195B along a vertical plane as shown in FIG. 1C. The ability to adjust upper compliant arms 120B along adjustable angle 195B may be important if frame adapter 130B is adjustable forward or backward with respect to the frame 140B in order to maintain a particular angle of contact between the upper compliant arm 120B and the wearer's head to avoid having certain edges of the upper compliant arms 120B in direct contact with the wearer's head. Furthermore, the ability to adjust the upper compliant arms 120B along adjustable angle 195B may also help improve the uniformity of the distribution of weight from the upper compliant arms 120B to the wearer's head.

Headset 100B in FIGS. 1B-1C includes two variations having a frame adapter 130B and upper compliant arms 120B. The two additional variants (e.g., frame adapter 130B and upper compliant arms 120B) are independent variations of headset 100B. Headset 100B may operate independently of and do not need to have frame adapter 130B and/or upper compliant arms 120B. Headset 100B describes alternative examples of how a headset 100B may be configured.

Compliant mechanisms are flexible mechanisms that transfer an input force or displacement to another point through elastic body. Compliant mechanisms can be designed to transfer an input force selectively across predetermined portions of its elastic body through deformation. Compliant mechanisms are elastic. Compliant mechanisms gain at least some of their mobility from the deflection of flexible members rather than from movable joints. Since compliant mechanisms rely on the deflection of flexible members, energy is stored in the form of strain energy in the flexible members. This stored energy is similar to the potential energy in a deflected spring, and the effects of springs may be integrated into a compliant mechanisms design to distribute an applied load. This can be used to easily store and/or transform energy to be released at a later time or in a different manner. A bow and arrow system is a simple example of this. Energy is stored in the limbs as the archer draws the bow. This potential energy is then transformed to kinetic energy of the arrow. These energy storage characteristics may also be used to design for specific force-deflection properties, or to cause a mechanism to tend to particular positions.

Compliant mechanisms are designed specifically to transfer an input force or displacement at one point of the mechanism to another point through elastic body deformation. A compliant mechanism may be designed based on a deformation profile and a slenderness ratio.

A deformation profile is the geometry obtained by an object after a prescribed loading is applied. For some embodiments, a deformation profile may be one that matches as closely as possible to the profile or geometry or contour of a wearer's head. Additionally, a point load applied to a fixed position of a compliant mechanism may be designed to non-uniformly or uniformly/near-uniformly distribute the load across the compliant mechanism through elastic body deformation based at least in part on a deformation profile. For example, the deformation profile of a compliant mounting arm may be designed to deform the compliant arm along the contour of a wearer's head while selectively distributing a normalizing load of the point load across the arm and onto the wearer's head.

In some embodiments (non-uniform distribution), the deformation of the compliant arm may distribute point loads of the load to particular pinpoint locations on the compliant arm to non-uniformly distribute the load as a point load to an anchor point/bone on a wearer's head. The anchor point/bone may be a strong bone structure that can withstand a load without discomfort, for example, the occipital bone, temporal bone, mastoid/styloid process, and ridge along the parietal bone.

In some embodiments, the deformation of the compliant arm (uniform/near-uniform distribution) may wrap around a wearer's head to uniformly/near-uniformly distribute the normalizing force onto the wearer's head. For a compliant mechanism, the design of the compliant mechanism may allow the transformation of the single point load via elastic body deformation of the entire compliant mechanism. This may be desired so that a single point load is not just transferred as another single point load, but instead, distributed as uniformly as possible across multiple points of the compliant mechanism body.

One of ordinary skill in the art appreciates a compliant mechanism can be designed to either uniformly or non-uniformly distribute a load. In some embodiments, a compliant mechanism may be designed to achieve both types of load distribution results, wherein certain portions of the compliant arm may be designed to uniformly distribute a portion of the load while other portions of the compliant arm may be designed to non-uniformly distribute a portion of the load to an anchor point/bone.

FIG. 1D illustrates simplified examples of presentation presented by an extended reality (XR) device and perceived by a user due to the alignment between the XR device and the user in one or more embodiments. More specifically, 102D illustrates a simplified example where the XR device is acceptably aligned with the user. For example, the XR device may utilize a pair of projectors to project virtual contents to the pupils of the user that wears the XR device. When the pupils are located within their respective eye-boxes, the user may perceive the virtual contents as correctly or at least acceptably placed virtual contents as shown in 102D. On the other hand, when the pupils are outside their respective eye-boxes due to, for example, misalignment of the XR device, incorrect or imprecise determination of the centers of the eyes, etc., the virtual contents having different depths may suffer from parallax effects and appear misplaced as shown in 104D.

FIG. 1E illustrates a simplified schematic diagram illustrating two sets of targets that are properly aligned and presented to a user who perceives these two sets of targets via an XR device in some embodiments. More particularly, FIG. 1E illustrates that an eye of the user 102E having a nodal point 104E. FIG. 1E further illustrates an eye-box 103E. When the pupil of the eye 102E (or the eye itself) is within the eye-box 103E, the XR device may properly present images to the eye 102E in some embodiments. On the other hand, if the pupil or the eye 102E is outside the eye-box, the XR device or its optics is deemed misaligned with the eye 102E, and the resulting image representation may have a lower quality such as lower brightness, misplaced contents, and/or parallax effects, etc.

In some embodiments, an eye-box 103E may be determined by, for example, an eye tracking process or a gaze detection process which predicts or computes a nodal point for an eye and will be described in greater details below. In these embodiments, the nodal point may be deemed acceptable when the eye-box 103E encloses the pupil or the eye 102E. In some other embodiments, the nodal point may be deemed acceptable when the eye-box 103E encloses the nodal point 104E is within a threshold tolerance from the nominal center of the eye-box 103E. It shall be noted that not all XR devices have the capability of eye-tracking or gaze detection, and that even if some XR devices do have the capability of eye-tracking or gaze detection, such capability may malfunction, stop functioning, or produce inaccurate results (e.g., mis-computed nodal point location) in some embodiments. In these embodiments, various techniques described herein may accurately determine nodal point locations to perform the functions of eye-tracking or gaze detection or to calibrate the nodal points computed by eye-tracking or gaze detection.

A nodal point includes either of two points so located on the axis of a lens or optical system (e.g., an eye, the cornea of an eye, the lens of an eye, etc.) that any incident ray directed through one will produce a parallel emergent ray directed through the other; one of two points in a compound optic system so related that a ray directed toward the first point will appear to have passed through the second point parallel to its original direction. Either of a pair of points situated on the axis of an optical system so that any incident ray sent through one will produce a parallel emergent ray sent through the other. A nodal point of the eye may be referred to as the center of rotation of the eye. Any eye-movement you make involves a rotation of the visual axis about the nodal point, while a head movement involves a displacement of the nodal point. In some embodiments, an optical element (e.g., an eye, the cornea of an eye, the lens of an eye, etc.) may have two nodal points. These are defined as the two points in the optical element such that a light ray entering the optical element and hitting the nodal point appears to exit on the on the other side of the optical element from the other nodal point.

The first set of targets including target 110E and/or target 112E (e.g., a reticle, a point of a finite size, a set of points, a pattern, etc.) may be presented to the eye 102E. In some embodiments, the first set of targets may be presented at a first display at a first depth 106E to the user, and the first set of targets having target 114E and/or 116E may be presented at a second display at a second depth 112E to the user, where the second display at the second depth 112E is perceived as farther away from the eye 102E as the first display at the first depth 106E is perceived. In some embodiments, the first display may include a dimmer display with less brightness than, for example, the second display (e.g., an optical waveguide having a stack of one or more waveguides with diffractive and/or holographic optical elements) which serves the primary functions of presenting virtual contents to the user. In some of these embodiments, a dimmer display's only function is to present a set of targets to users for alignment purposes (e.g., by at least partially blocking ambient light). In some other embodiments, a dimmer display may serve to present a set of targets to users for alignment purposes as well as present, together with the other display, virtual contents to a user. In some embodiments, a dimmer display may include, for example, a liquid crystal display (LCD), an electrochromic device (ECD) comprising electrochromic materials that control one or more optical properties such as optical transmission, absorption, reflectance and/or emittance by electrochromism (e.g., a continual but reversible manner on application of voltage), or any other suitable technologies and materials for a less bright, dimmer display. In some other embodiments, a dimmer display may include one or more diffractive optical elements, one or more holographic optical elements, or a combination of one or more diffractive optical elements and one or more holographic optical elements that are embedded in a waveguide of one or more waveguides of the XR device.

In some embodiments, the first and second displays 106E and 112E may include separate optical guides, separate diffractive optical elements (DOEs), or separate holographic optical elements (HOEs) in the same stack of optical guides. In some other embodiments, the first and second displays 106E and 112E may be two separate stacks of optical elements. It shall be noted that although FIG. 1E illustrates the targets (e.g., 110E, 112E, 114E, and 116E) and the displays (106E and 112E) as if the targets are displayed on the displays 106E and 112E that are located at some distances from the eye, FIG. 1E actually conveys the concept that the targets represented by optical elements that are respectively located on the corresponding displays (e.g., a diffractive optical element, a holographic element, etc.) so that the user perceives the first targets (e.g., 110E or 112E) at a first depth illustrated as 106E as closer to the eye 102E than the second targets (114E or 116E) at the second depth illustrated as 112E.

In some embodiments, the first targets are presented to the user by a first display (e.g., a dimmer display) which may include one or more holographic optical elements (HOEs), one or more diffractive optical elements (DOEs), or a combination of one or more HOEs and one or more DOEs. In these embodiments, the second targets, which are farther away from the user than the first targets as perceived by the user, are presented to the user via a second display (e.g., an extended-reality or XR display). In some of these embodiments, the first display (e.g., the dimmer display) is closer to the user than the second display (e.g., the XR display) so that ambient light first passes through the XR display before hitting the dimmer display, and the first targets presented by the dimmer display are closer to the user than the second targets presented by the XR display are. In some other embodiments, the first display (e.g., the dimmer display) is farther away the user than the second display (e.g., the XR display) so that ambient light from the environment first passes through the dimmer display before hitting the XR display, although the first targets presented by the dimmer display are nevertheless closer to the user than the second targets presented by the XR display are (e.g., as perceived by the user). Yet in other embodiments, the first targets presented by the dimmer display are farther away from the user than the second targets presented by the XR display are, and the first display (e.g., the dimmer display) may be closer to (in some of these embodiments) or farther away from (in some other embodiments) the user than the second display (e.g., the XR display).

In some embodiments, when a first target and a second target is aligned within a certain threshold tolerance, the XR device presenting the first and second targets may be deemed as properly or acceptably aligned or fitted to a user. For example, the first target 110E and the second target 114E may be respectively fixed (e.g., fixed in a pixel coordinate system, fixed in a real-world coordinate system, etc.) at their respective locations when presented to and perceived by a user. When the XR device is properly aligned or fitted to the user's eye(s), the first target 110E (or 112E) and the second target 114E (or 116E) lie along the same gaze direction. That is, the eye 102E, the first target 110E, and the second target 114E lie along the same line or line segment. When the XR device is not properly aligned or fitted to the user's eyes, the eye 102E, the first target 110E (or 112E), and the second target 114E (or 116E) no longer lie along the same line or line segment. In these embodiments, the XR device may be adjusted relative to the user so as to achieve proper alignment or fit.

In some embodiments, the first target 110E (or 112E) and the second target 114E (or 116E) may be used to determine a nodal point 104E of the eye 102E. For example, once the first target 110E (or 112E) and the second target 114E (or 116E) are properly aligned, the eye 102E also lies along the line connecting the first target 110E (or 112E) and the second target 114E (or 116E). Therefore, the nodal point 104E for the eye 102E may be determined to be one depth (e.g., the depth data of the first target 110E or the depth data of the second target 114E) from a target (e.g., the first target 110E or the second target 114E).

In some embodiments, both first targets 110E and 112E as well as the second targets 114E and 116E may be presented to the eye 102E. Each pair of the first target and the second target may be properly aligned. For example, the first target 110E is aligned with the second target 114E, and the first target 112E is aligned with the second target 116E. Once these two pairs of targets are aligned, a nodal point 104E of the eye 102E may also be determined without using the depth data in some of these embodiments. For example, the nodal point 104E may be determined as the intersection of the first line connecting 110E and 114E and the second line connecting 112E and 116E.

FIG. 1F illustrates another simplified monocular example of presenting two targets at two displays for aligning an XR device or for determining a nodal point of an eye. The difference between FIG. 1F and FIG. 1E described above is that FIG. 1F illustrates the embodiments where a first target 110E is presented on a first display at a first depth 106E, and a second target 114E is presented on a second display at a second depth 112E. By aligning the first target 110E and the second target 114E (e.g., by adjusting the relative position of the XR device to the user with an adjustment mechanism, by moving one of the two targets to appear to align with the other target along the same line of sight, etc.), the XR device may be properly or acceptably aligned to the user, and the nodal point 104E of the eye 102E may be determined as described above with reference to FIG. 1E.

In some embodiments, aligning two targets comprises adjusting the relative position of the XR device to the user with an adjustment mechanism or adjusting one of the two targets to appear to align with the other target along the same line of sight. In these embodiments, the alignment process effectively brings the pupil and hence the nodal point 104E inside the eye-box 103E in such a way that the two targets at different depth appear to be aligned when perceived by the eye 102E.

FIG. 1G illustrates a simplified diagram of presenting two sets of targets to an eye of a user in a monocular alignment process in some embodiments. In these embodiments, the first set of targets (110E or 112E) may be created by a first optical element 106E (e.g., a first diffractive element or DOE, a first holographic optical element or HOE) of an XR device, and the second set of targets (114E or 116E) may be created by a second optical element 106E (e.g., a second DOE, a second HOE) of the XR device.

The first set of targets 110E and/or 112E may be presented to the user with the first DOE or first HOE in such a way that the user perceives the first set of targets at the first depth. Similarly, the second set of targets 114E and/or 116E may be presented to the user with the second DOE or second HOE in such a way that the user perceives the second set of targets at the second depth that is greater than the first depth. In some embodiments, the XR device uses one target from each of the first and second sets for the monocular alignment process. In some other embodiments, the XR device uses both targets from each of the first and second sets for the monocular alignment process.

FIG. 1H illustrates a portion of a simplified user interface for an alignment process in some embodiments. In these embodiments, a user interface may be presented to a user. The user may perceive the user interface as a three-dimensional interface that is perceived by the user as occupying one or more three-dimensional volumes (e.g., prisms in more detailed description below) within the physical environment in which the user is located. A portion 102H of the user interface may include one or more dynamically refreshed icons (e.g., a battery icon 104H illustrating some textual and/or graphical indication of the remaining battery capacity, etc.) and a widget 106H for invoking an alignment process.

A widget includes an application, or a component of an interface that enables a user to perform a function or access a service in some embodiments. A widget represents an element of a graphical user interface (GUI) that displays information or provides a specific way for a user to interact with, for example, the operating system of a computing device or an application in some embodiments. In addition or in the alternative, a widget may be an applet intended to be used within an application or web pages and represents a generic type of software application comprising portable code intended for one or more different software platforms. A widget may also include a graphical widget (e.g., a graphical control element or control) in a graphical user interface where a control is one or more software components that a user interacts with through direct manipulation to read or write information about an application.

The widget 106H may be interacted upon by the user via, for example, using a gesture, the user's hand, or a physical or virtual controller to manipulate (e.g., click) the widget 106H. The widget 106H may also be interacted upon by using a command such as a command from a command menu, a voice command, etc. Once interacted upon, the widget 106H triggers the execution of the alignment process to present two sets of targets at two different depths to the user. The presentation of the two sets of targets may be confined to the same area occupied by the widget 106H so that the two targets in the widget icon now dynamically change in response to the alignment process in some embodiments. In some other embodiments, the presentation of these two sets of targets may be presented in a close-up view showing two sets of targets that are subject to the manipulation of the alignment process that will be described in greater details below.

FIG. 1I illustrates a first state of two targets in an alignment process in some embodiments. More particularly, a user perceives these two targets 1102 and 104 as misaligned in this first state illustrated in FIG. 1I. In some embodiments, the alignment process presents textual, audible, and/or visual cues 108 and 110 to assist aligning the two targets 102 and 104. For example, if the alignment process is to adjust the second target 104 to the first target 102, the second target 104 needs to be moved to the left and also moved upwards. In this example, the user interface may display a first cue 108 to instruct the user that the second target needs to be moved to the left and a second cue 1110 to instruct the user that the second target needs to be moved upwards. In some embodiments, the length (or other characteristics such as color, shape, etc.) of the first and/or second cue corresponds to the amount of adjustment. For example, a longer arrowhead indicates a larger amount of adjustment while a shorter arrowhead indicates a smaller amount of adjustment.

FIG. 1J illustrates a second state of two targets in the alignment process in some embodiments. More particularly, FIG. 1J illustrates that compared to the first state illustrated in FIG. 1I, the second target 104J has been moved to the left and upwards in the second state although the first and the second targets are still not sufficiently aligned. The alignment process may provide in the user interface refreshed cues 108 and 110 to indicate that the second target 104 still needs to be move upwards and to the left, although at smaller amounts and hence shorter arrowheads indicating the respective directions and the smaller amounts of respective adjustments.

FIG. 1K illustrates a third state of two targets in the alignment process in some embodiments. More particularly, FIG. 1K illustrates that the second target 104 is now aligned horizontally with the first target 102 yet not vertically. As a result, only the vertical alignment cue 110 remains show the direction and/or amount of vertical adjustment that needs to be made to align the first and the second targets.

FIG. 1L illustrates a fourth, aligned state of two targets in the alignment process in some embodiments. More particularly, FIG. 1L illustrates that the first target 102 and the second target 104 are now acceptably or properly aligned horizontally and vertically. As a result, the alignment cue 108 and 110 are now replaced by some visual, audible, and/or textual indication 110 that the two targets are now acceptably or properly aligned.

FIG. 1M illustrates a simplified example of misaligned XR device relative to the user in some embodiments. In these embodiments, the XR device is shifted from its acceptably or properly aligned position 101M′ to the position 101M to the left. As a result of this misalignment, the first set of targets 106-1M and 108-1M, and the second set of target(s) 110M are presented to the user and deviates from their respective acceptably or properly aligned positions 106-2M, 108-2M, and 110-2M. In this binocular example, both eyes 102M and 102M′ having respective nodal points 104M and 104M′ as well as eye-boxes 103M and 103M′ now perceive the first targets 106-1M and 108-1M as misaligned from the second target 110-1M. In some embodiments, such misalignment between the XR device and the user may be adjusted using an alignment process described herein (e.g., moving the XR device or the optical components thereof form 110M to the left to 110M′) so that the first targets and the second target may be returned from the current position to their respective acceptably or properly aligned positions 106-2M, 108-2M, and 110-2M.

FIG. 1N illustrates a simplified example binocular alignment process in some embodiments. In this simplified example, first targets 106N and 108N are respectively presented to the left eye 102N (having the eye-box 103N and nodal point 104N) and the right eye 102N′ (having the eye-box 103N′ and nodal point 104N′) on a display plane at a first depth. A second target 110N is presented on a second display plane at a second depth that is greater than the first depth. When the XR device is acceptably or properly fitted or aligned to the user or when the nodal points of the respective eyes are acceptably or properly determined as shown in FIG. 1N, the user perceives the first target 106N and the second target 110N as well as the first target 108N and the second target 110N as aligned with each other.

In some embodiments, the binocular alignment process illustrated in FIG. 1N may be performed one eye at a time. In some other embodiments, the binocular alignment process illustrated in FIG. 1N may be performed for both eyes at the same time. Once the second target 110N is respectively aligned with the first targets 106N and 108N, the respective nodal points 104N and 104N′ may be determined. For example, the nodal point 104N may be determined as the first depth away from the first target 106N along the line connecting the first target 106N and the second target 110N. Similarly, the nodal point 104N′ may also be determined as the second depth away from the second target 110N along the line connecting the first target 108N and the second target 110N.

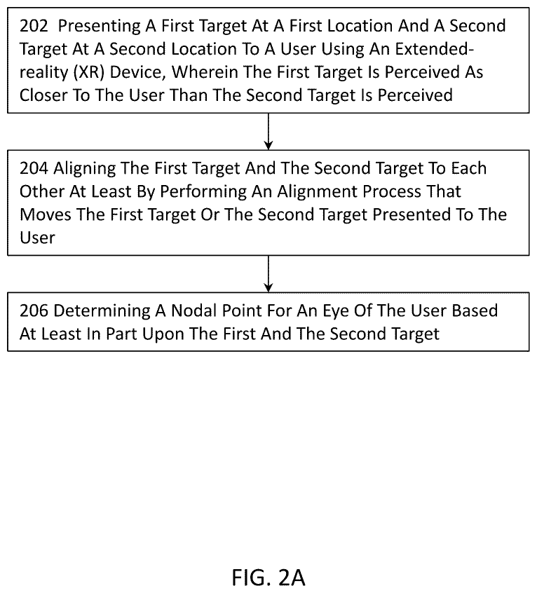

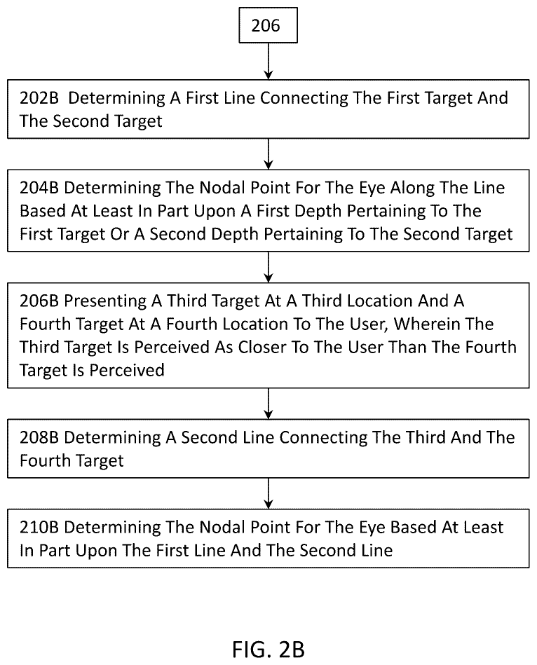

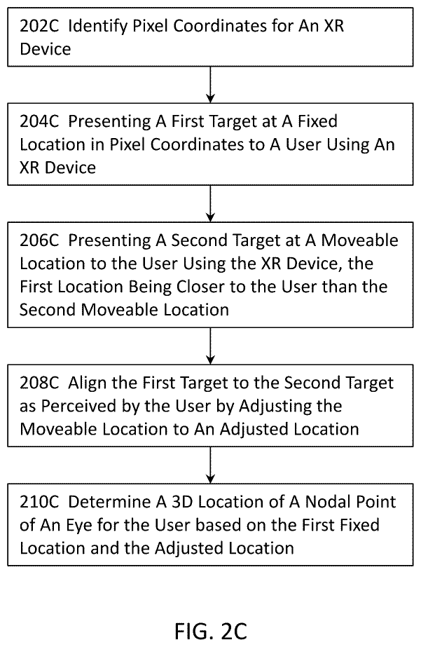

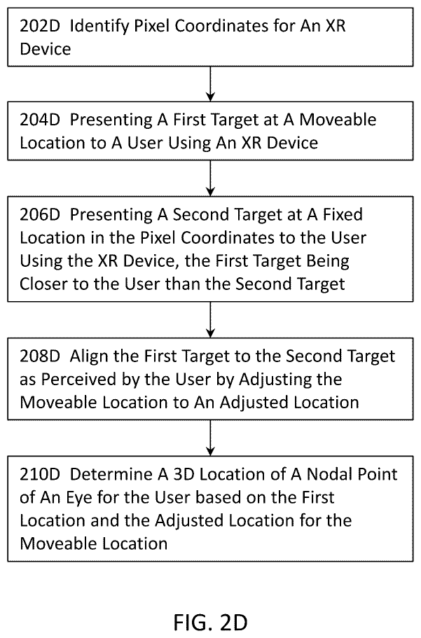

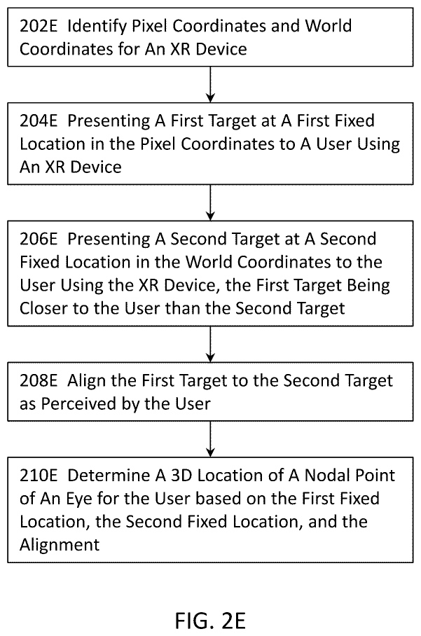

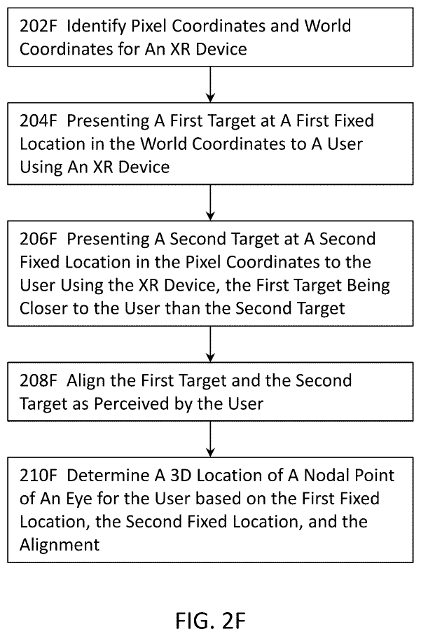

FIG. 2A illustrates a high-level block diagram for a system or method for determining a nodal point of an eye with an alignment process in some embodiments. At 202, a first target and a second target may be respectively presented at a first location and a second location to a user using an extended-reality (XR) device. It shall be noted that the term extended-reality or XR may generally refer to virtual-reality (VR), mixed-reality (MR), augmented-reality (AR), and/or extended-reality (XR) as generally understood in the field. The first and the second targets may be presented in such a way that the user perceives the first target as closer to the user than the second target is perceived. For example, the XR device may project a first light beam to the eye(s) of the user for the first target so that the first target is perceived by the user as being at a first depth; and the XR device may project a second light beam to the eye(s) of the user for the second target so that the second target is perceived by the user as being at a second depth.

The first target and the second target may be aligned to each other at 204 at least by performing an alignment process that adjusts, with respect to the user, the first target and/or the second target presented to the user. In some embodiments, the alignment process adjusts the first target that is perceived by the user as closer to the user than the second target is perceived. In some other embodiments, the alignment process adjusts the second target that is perceived by the user as farther from the user than the first target is perceived. Yet in other embodiments, the alignment process adjusts both the first and the second targets. For example, a user may use a physical or virtual controller, a voice command or menu command, a gesture, or the user hand to manipulate the first target (or the second target) to move the first target (or the second target) towards the second target (or the first target) until the alignment process or the XR device determines that the two targets are acceptably or properly aligned (e.g., the locations of the two targets are within some threshold tolerance).

A nodal point may be determined at 206 for an eye of the user based at least in part upon the first target and the second target. For example, once the first target and the second target are aligned with each other, a line may be constructed to connect the first and the second targets. Due to the alignment of the two targets as perceived by the user's eye(s), the user's eye(s) is determined to fall along the same line connecting the first and the second targets. Because the XR device generates the first target and the second target at the first depth and the second depth, respectively the align process may thus determine the nodal point of an eye to be the first depth away from the first target or the second depth away from the second target. In some embodiments, multiple such lines may be constructed (e.g., using multiple pairs of (first target, second target)). In these embodiments, a nodal point of an eye may be determined using the intersection of these multiple lines, without referencing the depth data or coordinate values pertaining to any targets.

FIG. 2B illustrates more details of a portion of the high-level block diagram illustrated in FIG. 2A. More specifically, FIG. 2B illustrates more details about determining a nodal point of an eye for a user wearing an XR device in some embodiments. In these embodiments, a first line or line segment (collectively “line”) connecting the first target and the second target may be determined at 202B once the first and the second targets are aligned to each other with respect to at least one eye of the user. A nodal point for the at least one eye may be determined at 204B along the aforementioned line based at least in part upon a first depth pertaining to the first target or a second depth pertaining to the second target. For example, once the first target and the second target are aligned with each other, a line may be constructed to connect the first and the second targets. Due to the alignment of the two targets as perceived by the user's eye(s), the user's eye(s) is determined to fall along the same line connecting the first and the second targets. Because the XR device generates the first target and the second target at the first depth and the second depth, respectively the align process may thus determine the nodal point of an eye to be the first depth away from the first target or the second depth away from the second target.

In some embodiments, instead of determining the nodal point at 204B, a third target and a fourth target may be respectively presented to the user at 206B at a third location and a fourth location so that the user perceives the third target as being closer to the user than the fourth target is perceived. Once the third target and the fourth target are aligned to each other (e.g., using the alignment process described herein), a second line may then be determined by connecting the corresponding points of the third and the fourth targets at 208B. With the third and the fourth targets being aligned with each other, the alignment process infers that the at least one eye of the user also falls along the line connecting the third and the fourth targets. At 210B, the nodal point for the at least one eye for which the alignment process is performed may be determined based at least in part upon the first line determined at 202B and the second line determined at 208B. For example, the nodal point may be determined as the intersection of the first and the second lines.

FIG. 2C illustrates an example block diagram for a method or system for determining a nodal point of an eye with an alignment process in some embodiments. In these embodiments, a pixel coordinate system may be identified at 202C. A pixel coordinate system expresses each pixel in a digital image or on a display with a set of coordinate values (e.g., integer values or any other suitable values). For example, a pixel having the coordinates (10, 8) lies in column number ten (10) and row number row (8) where columns are number from left to right, and rows are numbered from to bottom. The column number and/or the row number may start with zero (0) in some embodiments or one (1) in some other embodiments. In some other embodiments, columns may be numbered from right to left, and/or rows may be numbered from bottom to top (e.g., in OpenGL). Therefore, the numbering scheme is not considered as limiting the scope of various embodiments described herein, unless otherwise explicitly recited or described.

A first target may be presented at a first location in the pixel coordinate system to a user using an extended-reality (XR) device at 204C. In some embodiments, the first location is a fixed location whereas the first location is a movable location in some other embodiments. A second target may be presented at a second location to the user using the extended-reality (XR) device at 206C. In some embodiments, the second location comprises a movable location whereas the second location is a fixed location in some other embodiments. For example, the location of the second target may be manipulated by an alignment process so that a user may use, for example, a gesture, the user's hand, or a physical or virtual controller, or a command such as a command from a command menu, a voice command, etc. to manipulate the location of the second target to different locations.

The first target and the second target may be aligned at 208C as perceived by the user through the XR device by adjusting the second location of the second target to an adjusted location so that the first and the second targets are perceived by the user as being aligned with each other (e.g., along the same line of sight within a threshold tolerance). A nodal point (e.g., a three-dimensional nodal point in a physical space or in a local coordinate system of the XR device) may be determined at 210C for an eye for which the aforementioned alignment process based at least in part upon the first fixed location identified at 204C and the adjusted location determined at 208C. For example, the nodal point may be determined along the line connecting the first and the second targets at a first depth value from the first target or a second depth value from the second target.

FIG. 2D illustrates another example block diagram for a method or system for determining a nodal point of an eye with an alignment process in some embodiments. In these embodiments, a pixel coordinate system may be identified at 202D. A first target may be presented at a moveable location to a user using an extended-reality (XR) device at 204D. For example, the location of the first target may be manipulated by an alignment process so that a user may use, for example, a gesture, the user's hand, or a physical or virtual controller, or a command such as a command from a command menu, a voice command, etc. to manipulate the location of the second target to different locations. A second target may be presented at a fixed location in the pixel coordinate system to the user using the extended-reality (XR) device at 206D.

The first target and the second target may be aligned at 208D as perceived by the user through the XR device by adjusting the moveable location of the first target to an adjusted location so that the first and the second targets are perceived by the user as being aligned with each other (e.g., along the same line of sight within a threshold tolerance). A nodal point (e.g., a three-dimensional nodal point in a physical space or in a local coordinate system of the XR device) may be determined at 210D for an eye for which the aforementioned alignment process based at least in part upon the adjusted location determined at 208D and the fixed location determined for the second target at 206D. For example, the nodal point may be determined along the line connecting the first and the second targets at a first depth value from the first target or a second depth value from the second target.

In some embodiments, both the first target(s) and the second target(s) may be moveable and may thus subject to change by an alignment process. In some embodiments, the alignment process or the XR device may present a list of multiple adjustment options and/or adjustment features for the user to choose from. Regardless of whether the first and second targets are fixed in one or more coordinate systems or moveable, the alignment process or the XR device may recommend one adjustment option and/or adjustment feature to the user in one of the aforementioned two displays (e.g., the dimmer display or the XR display) in some embodiments. Some example adjustment options and adjustment features include, for instance, the number of alignment features to be aligned, one or more different types of targets or reticles for alignment, alignment precision (e.g., high, average, coarse, etc.), moving or adjusting the XR device, adjusting one or more components (e.g., the aforementioned first display, the second display, adjustment mechanism, etc.), changing the user's head pose, gaze direction, head position and/or orientation, body position and/or orientation, etc. in a particular pattern or manner (e.g., tilting, turning, translating, etc.), adjusting one or more specific targets in one or more specific patterns or manners, or any other suitable alignment options and/or features.

In response to this list of alignment options and/or features, the user may select one option and/or feature (e.g., via a physical controller, a virtual controller, a gesture, or hand manipulation with the user's hand, etc.), and the XR device presents the needed function(s), widget(s), and/or instruction(s) for the selected alignment option and/or feature. For example, a user may select a first alignment features of a cross type and a second alignment feature of a dot type, both of which are to be aligned with another target(s). In some of these embodiments where a user selects an alignment option and/or feature, the XR device or the alignment process may automate the alignment process until the fit and/or alignment of the XR device is within a threshold tolerance from the desired or required alignment position, without user intervention. In some other embodiments where the alignment option and/or feature is completed in an automated manner, a user may be asked to confirm whether the alignment result is satisfactory from the user's perspective. If the user's feedback is affirmative, the alignment option and/or feature or the entire alignment process terminates. Otherwise, further adjustments may be performed manually or automatically until the user confirms that the alignment result is satisfactory.

FIG. 2E illustrates another example block diagram for a method or system for determining a nodal point of an eye with an alignment process in some embodiments. In these embodiments, a pixel coordinate system and a world coordinate system may be identified at 202E. As described above, a pixel coordinate system expresses each pixel in a digital image or on a display with a set of coordinate values (e.g., integer values or any other suitable values). A world coordinate system includes a coordinate system that is attached to or register a real-world location or feature in some embodiments. In some of these embodiments, a world coordinate system may refer to a global origin and may that represent a point, a node, or a feature with the same global coordinates that remain the same for any systems, regardless of the respective positions or orientations of these systems. In some other embodiments, a world coordinate system may be a local coordinate system that references a local origin or a relative origin so that the same point, node, or feature has the same world coordinates from multiple systems (e.g., two separate XR devices) the point, node, or feature located with respect to these multiple systems has the same coordinates if and only if these multiple systems are located at the same location and oriented in the same orientation.

A first target may be presented at a first location in the pixel coordinate system to a user using an extended-reality (XR) device at 204E. In some embodiments, the first location is a fixed location, whereas the first location is a movable location in some other embodiments, as perceived by a user. A second target may be presented at a second location in the world coordinate system to the user using the extended-reality (XR) device at 206E while the first target is perceived by the user as being closer to the user than the second target is perceived. That is, both the first and the second targets have fixed coordinates (although in different coordinate systems) while the first target is presented to the user at a shorter depth value. In some embodiments, the second location is a fixed location, whereas the second location is a movable location in some other embodiments, as perceived by a user.

The first target and the second target may be aligned at 208E as perceived by the user. With both the first and the second targets being fixed in their respective coordinate system, the alignment may be achieved by, for example, the user's moving his or her body position such as tilting and/or turning his or her head when the user wears the XR device on his or her head in some embodiments. In some other embodiments, the first and second targets may be aligned at 208E by adjusting the fit of the XR device using an adjustment mechanism (e.g., adjustable compliant arms described herein or other adjustment mechanisms such as a vertical and/or horizontal head strap with adjustability provisions like rack-and-pinion guide, etc. that provides a combination of horizontal, vertical, translational, and/or rotational adjustments). For example, the relative position of the XR device to the user may be adjusted with an adjustment mechanism to bring the fixed first and second targets into alignment with respect to at least one eye of the user.

A nodal point (e.g., a three-dimensional nodal point in a physical space or in a local coordinate system of the XR device) may be determined at 210E for an eye for which the aforementioned alignment process based at least in part upon the first and the second fixed location after the alignment is achieved at 208E. For example, the nodal point may be determined along the line connecting the first and the second targets at a first depth value from the first target or a second depth value from the second target.

FIG. 2F illustrates another example block diagram for a method or system for determining a nodal point of an eye with an alignment process in some embodiments. In these embodiments, a pixel coordinate system and a world coordinate system may be identified at 202F.

A first target may be presented at a fixed location in the world coordinate system to a user using an extended-reality (XR) device at 204F. A second target may be presented at a fixed location in the pixel coordinate system to the user using the extended-reality (XR) device at 206F while the first target is perceived by the user as being closer to the user than the second target is perceived. That is, both the first and the second targets have fixed coordinates (although in different coordinate systems) while the first target is presented to the user at a shorter depth value.

The first target and the second target may be aligned at 208F as perceived by the user. With both the first and the second targets being fixed in their respective coordinate systems, the alignment may be achieved by, for example, the user's moving his or her body position such as tilting and/or turning his or her head when the user wears the XR device on his or her head in some embodiments. In some other embodiments, the first and second targets may be aligned at 208F by adjusting the fit of the XR device using an adjustment mechanism (e.g., adjustable compliant arms described herein or other adjustment mechanisms such as a vertical and/or horizontal head strap with adjustability provisions like rack-and-pinion guide, etc. that provides a combination of horizontal, vertical, translational, and/or rotational adjustments). For example, the relative position of the XR device to the user may be adjusted with an adjustment mechanism to bring the fixed first and second targets into alignment with respect to at least one eye of the user.

A nodal point (e.g., a three-dimensional nodal point in a physical space or in a local coordinate system of the XR device) may be determined at 210F for an eye for which the aforementioned alignment process based at least in part upon the first and the second fixed location after the alignment is achieved at 208F. For example, the nodal point may be determined along the line connecting the first and the second targets at a first depth value from the first target or a second depth value from the second target.

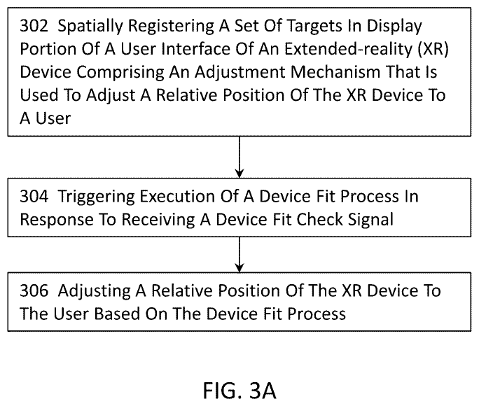

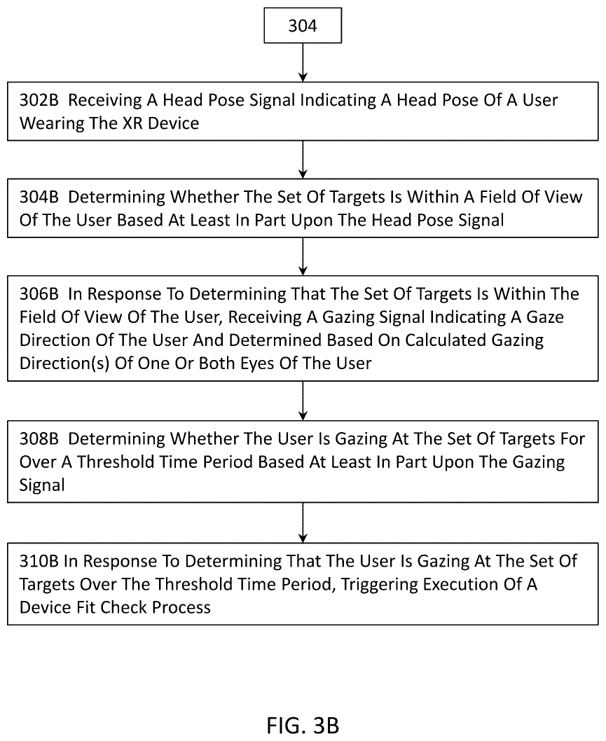

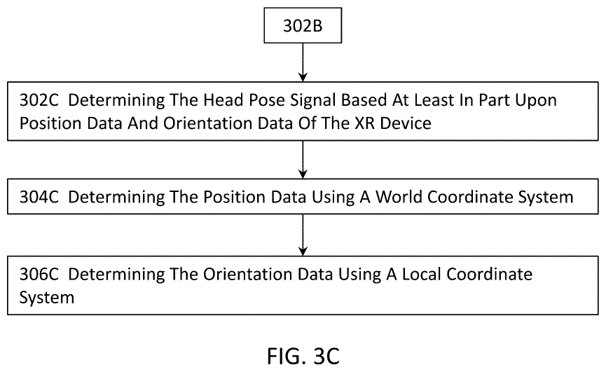

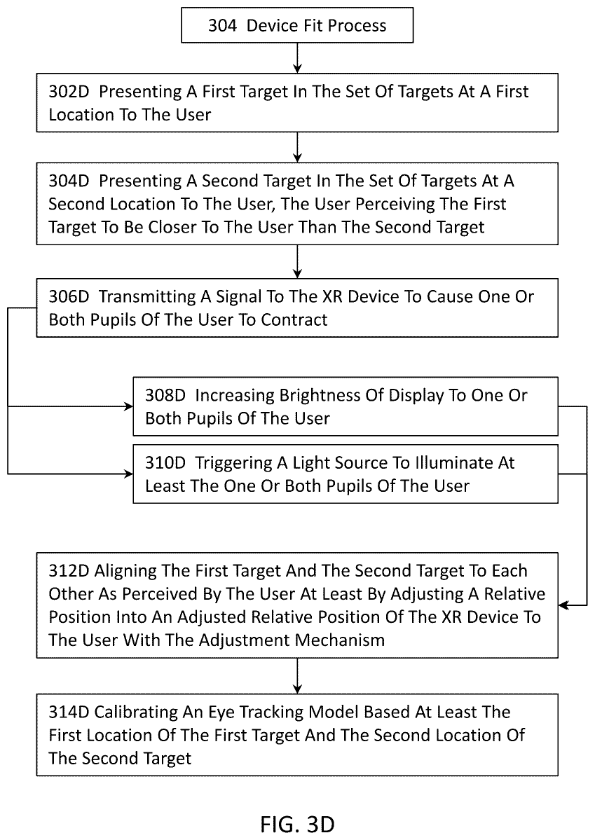

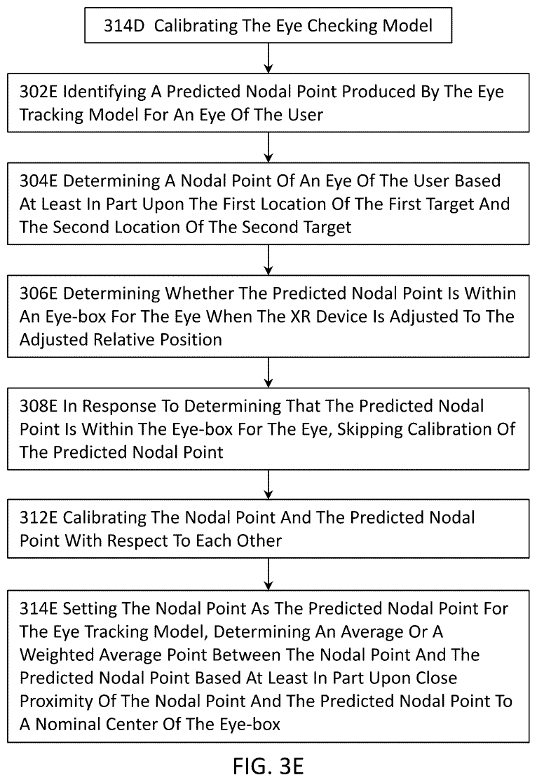

FIG. 3A illustrates a high-level block diagram for a method or system for performing a device fit process for an XR device in some embodiments. More specifically, a set of targets may be spatially registered at 302 in a display portion of a user interface of an extended-reality (XR) device having an adjustment mechanism that is used to adjust a relative position of the XR device relative to a user. In some of these embodiments, spatially registering a target includes associating the target with cartesian and/or polar coordinates or other location identification data in a coordinate system (e.g., a global coordinate system such as the aforementioned world coordinate system, a local coordinate system, a pixel coordinate system, etc.)

The execution of a device fit process may be triggered at 304 in response to the receipt of a device fit check signal. For example, a user may issue a device fit check signal by manipulating a widget in a user interface with the user's hand, gesture, a physical controller, or a virtual controller, issuing a command from a command menu or a voice command, gazing at the aforementioned widget for over a threshold time period, etc. Upon receiving the device fit check signal, an inter-process call or any other suitable interprocess communication (IPC) techniques may be used to invoke the execution of the device fit process at 304. In some embodiments, a device fit check signal comprises a command for fitting the XR device to a user. In some of these embodiments, the command comprises a gesture, an audio input, a user's staring at the set of targets for at least a threshold period of time, an interaction with an action widget corresponding to fitting the XR device to the user, or a selection of a menu item corresponding to fitting the XR device to the user from the user interface

The relative position of the XR device to the user may be adjusted at 306 based at least in part upon the device fit process. The relative position of the XR device to the user may be adjusted by using an adjustment mechanism such as adjustable compliant arms described below or other suitable adjustment mechanisms such as a vertical and/or horizontal head strap with adjustability provisions like rack-and-pinion guide, etc. that provides a combination of horizontal, vertical, translational, and/or rotational adjustments to alter the relative position of the XR device relative to the user. The adjustment mechanism may also include a locking mechanism which, until defeated or undone, ensures that the relative position of the XR device to the user remains substantially the same (e.g., deviations from the relative position are within the manufacturing tolerance of the XR device or its components thereof, within the slacks provided for fitting the XR device to the user, and/or within normal wear and tear such as deformation over time of the XR device or components thereof, etc.)

FIG. 3B illustrates more details about a portion of the high-level block diagram illustrated in FIG. 3A. More specifically, FIG. 3B illustrates more details about triggering the execution of a device fit process at 304 of FIG. 3A. In these embodiments, a head pose signal indicating a head pose of the user wearing the XR device may be received at 302B. At 304B, a determination may be made to decide whether the set of targets is within a field of view of the user based at least in part upon the head pose signal received at 302B.

For example, an interactable widget for triggering the execution of a device fit process may be presented in a three-dimensional virtual volume (e.g., a prism) outside the primary field of view (e.g., the field of view including one or more applications such as a Web browser, a productivity application, etc.) of the user wearing the XR device so that the user needs to change the field of view in order to interact with the interactable widget in order execute the device fit process. For instance, the interactable widget may be rendered in the prism to the side of the user, behind the user, etc. to avoid cluttering the current field of view. In some other embodiments, the interactable trigger may be rendered in the current field of view of the virtual user interface.

In response to determining that the set of targets or the interactable widget is within the field of view of the user, a gazing signal indicating a gaze direction of the user and determined based at least in part upon one or more computed gazing directions of one or more both eyes of the user may be received at 306B. In some embodiments, the gazing direction may be computed using eye tracking techniques that will be described in greater details below. In an example where the set of targets or interactable widget is rendered outside the primary field of view of the user wearing the XR device, a user may change his or her head pose to bring the user interface that is not visible by the user before changing the head pose to the user's changed field of view.

In these embodiments, the method or system described herein may continue to track the gaze direction(s) of the eye(s) of the user to determine the point or area of interest of the user in this changed field of view. In some other embodiments where the set of targets or the interactable widget is rendered within the current or primary field of view, the method or system described herein may also track the gaze direction(s) of the eye(s) of the user to determine the point or area of interest of the user in this changed field of view.

At 308B, the method or system may determine whether the set of targets or the interactable widget is interacted upon. For example, the method or system may determine whether the user is gazing at the set of targets or the interactable widget for over a threshold time period, whether the user has interacted with the set of targets or the interactable widget with his/her hand, gesture, virtual controller, or physical controller, or whether the user has issued a command to interact with the set of targets or the interactable widget or to invoke the execution of the device fit process. If the determination result is affirmative at 308B, the method or system may trigger the execution of the device fit process at 310B.

FIG. 3C illustrates more details about a portion of the high-level block diagram illustrated in FIG. 3A. More specifically, FIG. 3B illustrates more details about spatially registering a set of targets at 302 of FIG. 3A. In these embodiments, a head pose signal may be determined at 302C based at least in part upon position data and/or orientation data of the XR device. The position data of the XR device may be determined at 304C using a global or local world coordinate system.

As described above, a world coordinate system includes a coordinate system that is attached to or register a real-world location or feature in some embodiments. In some of these embodiments, a world coordinate system may refer to a global origin and may that represent a point, a node, or a feature with the same global coordinates that remain the same for any systems, regardless of the respective positions or orientations of these systems. In some other embodiments, a world coordinate system may be a local coordinate system that references a local origin or a relative origin so that the same point, node, or feature has the same world coordinates from multiple systems (e.g., two separate XR devices) the point, node, or feature located with respect to these multiple systems has the same coordinates if and only if these multiple systems are located at the same location and oriented in the same orientation.

The orientation data is specific to an XR device and may thus be determined at 306C by using a local coordinate system that is specific to the XR device for which the orientation data is to be determined. For example, an XR system may a fixed point or an arbitrary point as the origin and a specific direction or bearing (e.g., magnetic north, true north, etc.) or an arbitrary direction or bearing as the absolute local bearing or the relative bearing (e.g., relative to another physical or virtual object or feature) for the XR device. In some of these embodiments, this local coordinate system may nevertheless reference a physical feature or even the world coordinate system and establish a mapping between local coordinates and global coordinates if needed.

FIG. 3D illustrates an example block diagram for a device fit process that may be performed by a method or system illustrated in FIG. 3A in some embodiments. More specifically, FIG. 3D illustrates an example device fit process that may be performed at 304 of the high-level block diagram of FIG. 3A. In these embodiments, a first target in the set of targets may be presented at a first location to the user at 302D. For example, an XR device may utilize a first diffractive optical element (DOE) or a first holographic optical element (HOE) embedded or included in the optics of the XR device to render the first target (e.g., a point of a certain size, a plurality of points, a reticle, a pattern, or any combinations thereof, etc.) at a first depth or on a first focal plane at the first depth to the user.

A second target in the set of targets may be presented at a second location to the user at 304D so that the first target is perceived as closer to the user than the second target is perceived. For example, an XR device may utilize a first diffractive optical element (DOE) or a second holographic optical element (HOE) embedded or included in the optics of the XR device to render the second target (e.g., a point of a certain size, a plurality of points, a reticle, a pattern, or any combinations thereof, etc.) at a second depth or on a second focal plane at the second depth to the user.

These techniques described herein utilize the parallax effects for determining a nodal point for an eye of a user and also for properly fitting the XR device or any head-worn devices such as smart glasses, goggles, helmets or other devices with head-up displays, etc. The parallax effect includes the effect where the position or direction of an object appears to differ when viewed from different positions. Due to the parallax effect and the two or more targets presented at different depths from the user, the virtual objects presented to the user may appear to be more misaligned as the user moves or changes his or her viewing position or orientation. For example, the target closer to the user may appear to move at a faster speed than the target farther away from the user and thus further deteriorates the display quality when the viewing position and/or orientation changes. Some embodiments utilize this often-undesirable parallax effect as a positive feature to align devices to a user and to estimate nodal points of a user as described herein.

A signal may be optionally transmitted to the XR device at 306D to cause one or more pupils of the user to contract. As described herein, multiple targets are presented to a user of an XR device at different depths. In some cases where a user may tend to focus on the farther target(s) than on the closer target(s), such tendency may cause the closer target to be perceived as blurrier than the farther target. In addition or in the alternative, different users may have different closest focal distances so a first user may perceive a closer target with sufficient sharpness (e.g., sufficient for aligning this closer target to another farther target), but a second user may have a longer closest focal distance than the first user and hence perceive the same closer target without sufficient sharpness.

In some embodiments, these techniques may optionally send a signal to cause the user's pupil(s) to contract as a smaller pupil not only provides an increased depth of field so that objects in a greater range may be rendered sharper to users but also reduces aberrations that usually cause images to appear soft or blurry. In some of these embodiments, the signal may cause to increase the brightness of the entire closer target or a portion thereof (e.g., the background portion of the closer target) at 308D so that the user's pupil(s) may contract in response to the brighter image(s). In some other embodiments, the signal may cause one or more light sources at 310D to illuminate an area of an eye of the user (e.g., the pupil area) to cause the pupil of the user to contract.

The first target and the second target may then be aligned to each other at 312D as perceived by the user at least by adjusting the relative position into an adjusted relative position of the XR device relative to the user with the adjustment mechanism. As described herein, an adjustment mechanism may include, for instance, adjustable compliant arms described below or other suitable adjustment mechanisms such as a vertical and/or horizontal head strap with adjustability provisions such as rack-and-pinion guide, etc. that provides a combination of horizontal, vertical, translational, and/or rotational adjustments to alter the relative position of the XR device to the user. The adjustment mechanism may also optionally include a locking mechanism which, until defeated or undone, ensures that the relative position of the XR device to the user remains substantially the same (e.g., deviations from the relative position are within the manufacturing tolerance of the XR device or its components thereof, within the slacks provided for fitting the XR device to the user, and/or within normal wear and tear such as deformation over time of the XR device or components thereof, etc.)

In some embodiments, a nodal point of an eye of the user may be estimated once the first target and the second target are aligned with the adjustment mechanism at 312D. This nodal point may be used at 314D for calibrating an eye tracking model of an XR device having the eye tracking model or in computing the nodal point of an XR device that does not have an eye tracking model or does have an eye tracking model that is either malfunctioned or produces inaccurate eye tracking. For XR devices that do not have eye-tracking functionality, the computed nodal point of an eye of the user may be used as, for instance, the eye center for presenting contents to the user. For XR devices that have eye-tracking functionality, the computed nodal point may be used to calibrate or co-witness the nodal point determined by the eye-tracking functionality. For example, when an XR headset is acceptably or properly aligned to a user, the user has properly perceived the multiple targets in sufficient alignment (e.g., the pupils of the user are located within their respective eye-boxes within a threshold tolerance). Therefore, the nodal points thus determined may be used as a ground truth to calibrate the eye-tracking model by setting the nodal point data to the eye-tracking model so that the XR device more accurately captures where the eyes of the user are located and may thus provide better quality presentations to the user.

FIG. 3E illustrates more details about a portion of the block diagram illustrated in FIG. 3D in some embodiments. More specifically, FIG. 3E illustrates more details about calibrating an eye tracking model at 314D of FIG. 3D. In some embodiments, a predicted nodal point that is produced by the eye tracking model may be identified at 302E for an eye of the user. A nodal point of an eye of the user may be determined at 304E based at least in part upon the first location of the first target and the second location of the second target. A determination may be made at 306E to decide whether the predicted nodal point from the eye tracking model is within an eye-box for the eye when the XR device is adjusted to the adjusted relative position.

In response to determining that the predicted nodal point by the eye tracking model is within the eye-box for the eye, calibration of the predicted nodal point produced by the eye tracking model may be optionally skipped at 308E because the determination that the predicted nodal point of the eye still lies within the eye-box indicates that the eye-tracking model provides reasonably accurate estimation of the nodal point for the eye, and the additional calibration may thus be skipped in some embodiments.

In some embodiments, the nodal point and the predicted nodal point may be calibrated at 312E with respect to each other. At 314E, the nodal point may be set as or assigned to the predicted nodal point for the eye tracking model. In some of these embodiments, an average or a weighted average point between the nodal point and the predicted nodal point may be assigned to the predicted nodal point for the eye tracking model at 314E based at least in part upon close proximity of the nodal point and the predicted nodal point to a nominal center of the eye-box. For example, the respective weights for the nodal point and the predicted nodal point may be determined based at least in part upon their respective deviations from, for instance, the center of an eye-box so that a nodal point corresponding to a larger deviation is assigned a smaller weight, and a nodal point corresponding to a smaller deviation is assigned a greater weight.

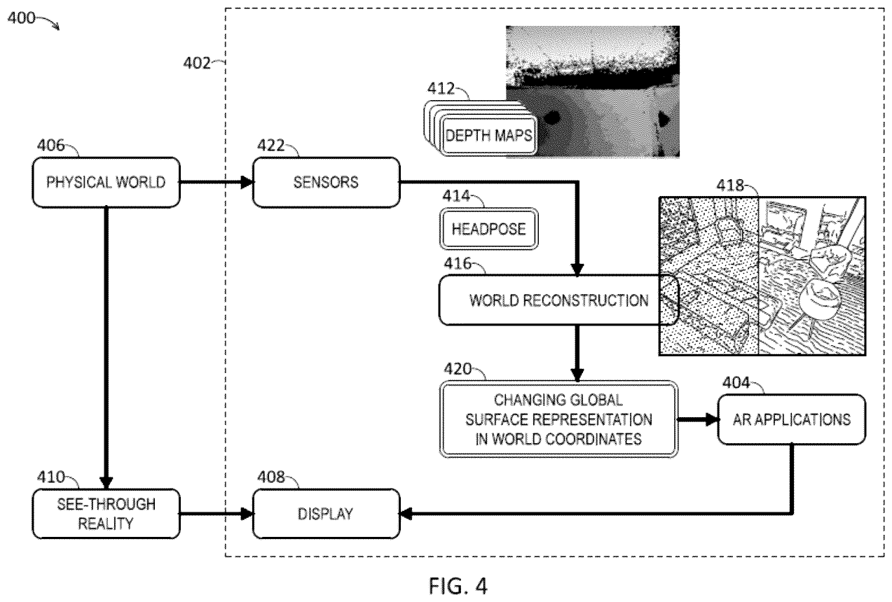

FIG. 4 illustrates an example schematic diagram illustrating data flow 400 in an XR system configured to provide an experience of extended-reality (XR) contents interacting with a physical world, according to some embodiments. More particularly, FIG. 1C illustrates an XR system 402 configured to provide an experience of XR contents interacting with a physical world 406, according to some embodiments. The XR system 402 may include a display 408. In the illustrated embodiment, the display 408 may be worn by the user as part of a headset such that a user may wear the display over their eyes like a pair of goggles or glasses. At least a portion of the display may be transparent such that a user may observe a see-through reality 410. The see-through reality 410 may correspond to portions of the physical world 406 that are within a present viewpoint of the XR system 402, which may correspond to the viewpoint of the user in the case that the user is wearing a headset incorporating both the display and sensors of the XR system to acquire information about the physical world.

XR contents may also be presented on the display 408, overlaid on the see-through reality 410. To provide accurate interactions between XR contents and the see-through reality 410 on the display 408, the XR system 402 may include sensors 422 configured to capture information about the physical world 406. The sensors 422 may include one or more depth sensors that output depth maps 412. Each depth map 412 may have multiple pixels, each of which may represent a distance to a surface in the physical world 406 in a particular direction relative to the depth sensor. Raw depth data may come from a depth sensor to create a depth map. Such depth maps may be updated as fast as the depth sensor can form a new image, which may be hundreds or thousands of times per second. However, that data may be noisy and incomplete, and have holes shown as black pixels on the illustrated depth map.

The system may include other sensors, such as image sensors. The image sensors may acquire information that may be processed to represent the physical world in other ways. For example, the images may be processed in world reconstruction component 416 to create a mesh, representing connected portions of objects in the physical world. Metadata about such objects, including for example, color and surface texture, may similarly be acquired with the sensors and stored as part of the world reconstruction.

The system may also acquire information about the headpose of the user with respect to the physical world. In some embodiments, sensors 410 may include inertial measurement units (IMUs) that may be used to compute and/or determine a headpose 414. A headpose 414 for a depth map may indicate a present viewpoint of a sensor capturing the depth map with six degrees of freedom (6 DoF), for example, but the headpose 414 may be used for other purposes, such as to relate image information to a particular portion of the physical world or to relate the position of the display worn on the user's head to the physical world. In some embodiments, the headpose information may be derived in other ways than from an IMU, such as from analyzing objects in an image.

The world reconstruction component 416 may receive the depth maps 412 and headposes 414, and any other data from the sensors, and integrate that data into a reconstruction 418, which may at least appear to be a single, combined reconstruction. The reconstruction 418 may be more complete and less noisy than the sensor data. The world reconstruction component 416 may update the reconstruction 418 using spatial and temporal averaging of the sensor data from multiple viewpoints over time.

The reconstruction 418 may include representations of the physical world in one or more data formats including, for example, voxels, meshes, planes, etc. The different formats may represent alternative representations of the same portions of the physical world or may represent different portions of the physical world. In the illustrated example, on the left side of the reconstruction 418, portions of the physical world are presented as a global surface; on the right side of the reconstruction 418, portions of the physical world are presented as meshes. The reconstruction 418 may be used for XR functions, such as producing a surface representation of the physical world for occlusion processing or physics-based processing. This surface representation may change as the user moves or objects in the physical world change. Aspects of the reconstruction 418 may be used, for example, by a component 420 that produces a changing global surface representation in world coordinates, which may be used by other components.

The XR contents may be generated based on this information, such as by XR applications 404. An XR application 404 may be a game program, for example, that performs one or more functions based on information about the physical world, such visual occlusion, physics-based interactions, and environment reasoning. It may perform these functions by querying data in different formats from the reconstruction 418 produced by the world reconstruction component 416. In some embodiments, component 420 may be configured to output updates when a representation in a region of interest of the physical world changes. That region of interest, for example, may be set to approximate a portion of the physical world in the vicinity of the user of the system, such as the portion within the view field of the user, or is projected (predicted/determined) to come within the view field of the user. The XR applications 404 may use this information to generate and update the XR contents. The virtual portion of the XR contents may be presented on the display 408 in combination with the see-through reality 410, creating a realistic user experience.

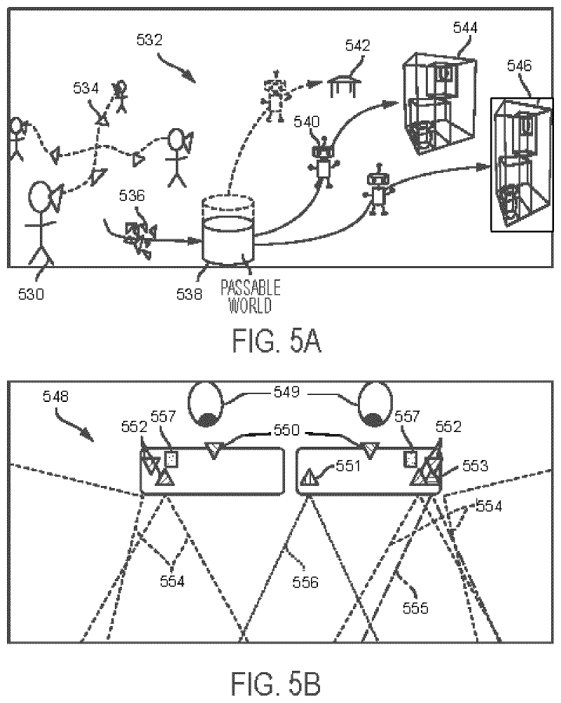

FIG. 5A illustrates a user 530 wearing an XR display system rendering AR content as the user 530 moves through a physical world environment 532 (hereinafter referred to as “environment 532”) in some embodiments. The information captured by the AR system along the movement path of the user may be processed into one or more tracking maps. The user 530 positions the AR display system at positions 534, and the AR display system records ambient information of a passable world (e.g., a digital representation of the real objects in the physical world that can be stored and updated with changes to the real objects in the physical world) relative to the positions 534. That information may be stored as poses in combination with images, features, directional audio inputs, or other desired data. The positions 534 are aggregated to data inputs 536, for example, as part of a tracking map, and processed at least by a passable world module 538, which may be implemented, for example, by processing on a remote processing module 572. In some embodiments, the passable world module 538 may include the headpose component 514 and the world reconstruction component 516, such that the processed information may indicate the location of objects in the physical world in combination with other information about physical objects used in rendering virtual content.

The passable world module 538 determines, at least in part, where and how AR content 540 can be placed in the physical world as determined from the data inputs 536. The AR content is “placed” in the physical world by presenting via the user interface both a representation of the physical world and the AR content, with the AR content rendered as if it were interacting with objects in the physical world and the objects in the physical world presented as if the AR content were, when appropriate, obscuring the user's view of those objects. In some embodiments, the AR content may be placed by appropriately selecting portions of a fixed element 542 (e.g., a table) from a reconstruction (e.g., the reconstruction 518) to determine the shape and position of the AR content 540. As an example, the fixed element may be a table and the virtual content may be positioned such that it appears to be on that table. In some embodiments, the AR content may be placed within structures in a field of view 544, which may be a present field of view or an estimated future field of view. In some embodiments, the AR content may be persisted relative to a model 546 of the physical world (e.g., a mesh).

As depicted, the fixed element 542 serves as a proxy (e.g., digital copy) for any fixed element within the physical world which may be stored in the passable world module 538 so that the user 530 can perceive content on the fixed element 542 without the system having to map to the fixed element 542 each time the user 530 sees it. The fixed element 542 may, therefore, be a mesh model from a previous modeling session or determined from a separate user but nonetheless stored by the passable world module 538 for future reference by a plurality of users. Therefore, the passable world module 538 may recognize the environment 532 from a previously mapped environment and display AR content without a device of the user 530 mapping all or part of the environment 532 first, saving computation process and cycles and avoiding latency of any rendered AR content.

The mesh model 546 of the physical world may be created by the AR display system and appropriate surfaces and metrics for interacting and displaying the AR content 540 can be stored by the passable world module 538 for future retrieval by the user 530 or other users without the need to completely or partially recreate the model. In some embodiments, the data inputs 536 are inputs such as geolocation, user identification, and current activity to indicate to the passable world module 538 which fixed element 542 of one or more fixed elements are available, which AR content 540 has last been placed on the fixed element 542, and whether to display that same content (such AR content being “persistent” content regardless of user viewing a particular passable world model).

Even in embodiments in which objects are considered to be fixed (e.g., a kitchen table), the passable world module 538 may update those objects in a model of the physical world from time to time to account for the possibility of changes in the physical world. The model of fixed objects may be updated with a very low frequency. Other objects in the physical world may be moving or otherwise not regarded as fixed (e.g., kitchen chairs). To render an AR scene with a realistic feel, the AR system may update the position of these non-fixed objects with a much higher frequency than is used to update fixed objects. To enable accurate tracking of all of the objects in the physical world, an AR system may draw information from multiple sensors, including one or more image sensors.

FIG. 5B illustrates a simplified example schematic of a viewing optics assembly and attendant components. In some embodiments, two eye tracking cameras 550, directed toward user eyes 549, detect metrics of the user eyes 549, such as eye shape, eyelid occlusion, pupil direction and glint on the user eyes 549.

In some embodiments, one of the sensors may be a depth sensor 551, such as a time-of-flight sensor, emitting signals to the world and detecting reflections of those signals from nearby objects to determine distance to given objects. A depth sensor, for example, may quickly determine whether objects have entered the field of view of the user, either as a result of motion of those objects or a change of pose of the user. However, information about the position of objects in the field of view of the user may alternatively or additionally be collected with other sensors. Depth information, for example, may be obtained from stereoscopic visual image sensors or plenoptic sensors.

In some embodiments, world cameras 552 record a greater-than-peripheral view to map and/or otherwise create a model of the environment 532 and detect inputs that may affect AR content. In some embodiments, the world camera 552 and/or camera 553 may be grayscale and/or color image sensors, which may output grayscale and/or color image frames at fixed time intervals. Camera 553 may further capture physical world images within a field of view of the user at a specific time. Pixels of a frame-based image sensor may be sampled repetitively even if their values are unchanged. Each of the world cameras 552, the camera 553 and the depth sensor 551 have respective fields of view of 554, 555, and 556 to collect data from and record a physical world scene.

Inertial measurement units 557 may determine movement and orientation of the viewing optics assembly 548. In some embodiments, inertial measurement units 557 may provide an output indicating a direction of gravity. In some embodiments, each component is operatively coupled to at least one other component. For example, the depth sensor 551 is operatively coupled to the eye tracking cameras 550 as a confirmation of measured accommodation against actual distance the user eyes 549 are looking at.

It should be appreciated that a viewing optics assembly 548 may include components instead of or in addition to the components illustrated. In some embodiments, for example, a viewing optics assembly 548 may include two world camera 552 instead of four. Alternatively or additionally, cameras 552 and 553 need not capture a visible light image of their full field of view. A viewing optics assembly 548 may include other types of components. In some embodiments, a viewing optics assembly 548 may include one or more dynamic vision sensor (DVS), whose pixels may respond asynchronously to relative changes in light intensity exceeding a threshold.

In some embodiments, a viewing optics assembly 548 may not include the depth sensor 551 based on time-of-flight information. In some embodiments, for example, a viewing optics assembly 548 may include one or more plenoptic cameras, whose pixels may capture light intensity and an angle of the incoming light, from which depth information can be determined. For example, a plenoptic camera may include an image sensor overlaid with a transmissive diffraction mask (TDM). Alternatively or additionally, a plenoptic camera may include an image sensor containing angle-sensitive pixels and/or phase-detection auto-focus pixels (PDAF) and/or micro-lens array (MLA). Such a sensor may serve as a source of depth information instead of or in addition to depth sensor 551.

It also should be appreciated that the configuration of the components in FIG. 5B is provided as an example. A viewing optics assembly 548 may include components with any suitable configuration, which may be set to provide the user with the largest field of view practical for a particular set of components. For example, if a viewing optics assembly 548 has one world camera 552, the world camera may be placed in a center region of the viewing optics assembly instead of at a side.

Information from the sensors in viewing optics assembly 548 may be coupled to one or more of processors in the system. The processors may generate data that may be rendered so as to cause the user to perceive virtual content interacting with objects in the physical world. That rendering may be implemented in any suitable way, including generating image data that depicts both physical and virtual objects. In other embodiments, physical and virtual content may be depicted in one scene by modulating the opacity of a display device that a user looks through at the physical world. The opacity may be controlled so as to create the appearance of the virtual object and also to block the user from seeing objects in the physical world that are occluded by the virtual objects. In some embodiments, the image data may only include virtual content that may be modified such that the virtual content is perceived by a user as realistically interacting with the physical world (e.g., clip content to account for occlusions), when viewed through the user interface.

The location on the viewing optics assembly 548 at which content is displayed to create the impression of an object at a particular location may depend on the physics of the viewing optics assembly. Additionally, the pose of the user's head with respect to the physical world and the direction in which the user's eyes are looking may impact where in the physical world content displayed at a particular location on the viewing optics assembly content will appear. Sensors as described above may collect this information, and or supply information from which this information may be calculated, such that a processor receiving sensor inputs may compute where objects should be rendered on the viewing optics assembly 548 to create a desired appearance for the user.

Regardless of how content is presented to a user, a model of the physical world may be used so that characteristics of the virtual objects, which can be impacted by physical objects, including the shape, position, motion, and visibility of the virtual object, can be correctly computed. In some embodiments, the model may include the reconstruction of a physical world, for example, the reconstruction 518.

That model may be created from data collected from sensors on a wearable device of the user. Though, in some embodiments, the model may be created from data collected by multiple users, which may be aggregated in a computing device remote from all of the users (and which may be “in the cloud”).

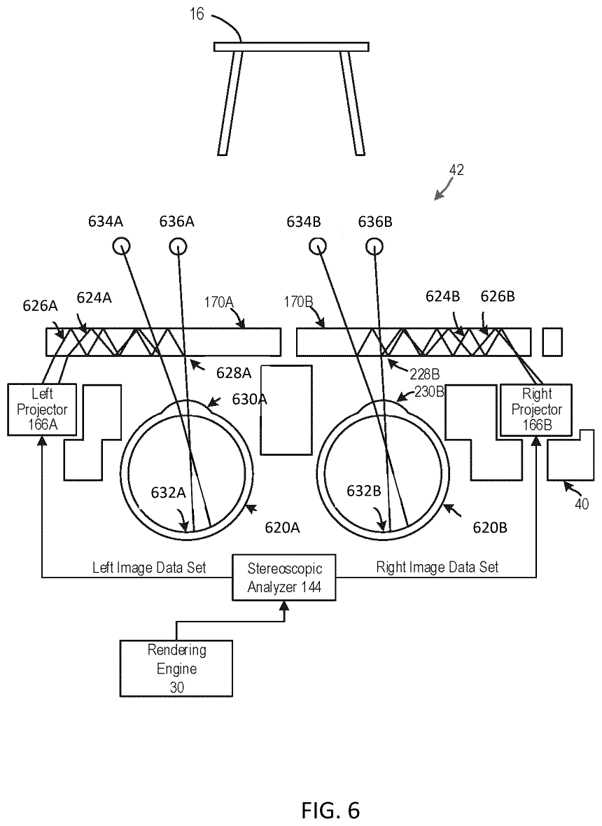

FIG. 6 illustrates the display system 42 in greater details in some embodiments. The display system 42 includes a stereoscopic analyzer 144 that is connected to the rendering engine 30 and forms part of the vision data and algorithms.

The display system 42 further includes left and right projectors 166A and 166B and left and right waveguides 170A and 170B. The left and right projectors 166A and 166B are connected to power supplies. Each projector 166A and 166B has a respective input for image data to be provided to the respective projector 166A or 166B. The respective projector 166A or 166B, when powered, generates light in two-dimensional patterns and emanates the light therefrom. The left and right waveguides 170A and 170B are positioned to receive light from the left and right projectors 166A and 166B, respectively. The left and right waveguides 170A and 170B are transparent waveguides.

In use, a user mounts the head mountable frame 40 to their head. Components of the head mountable frame 40 may, for example, include a strap (not shown) that wraps around the back of the head of the user. The left and right waveguides 170A and 170B are then located in front of left and right eyes 620A and 620B of the user.

The rendering engine 30 enters the image data that it receives into the stereoscopic analyzer 144. The image data is three-dimensional image data of the local content. The image data is projected onto a plurality of virtual planes. The stereoscopic analyzer 144 analyzes the image data to determine left and right image data sets based on the image data for projection onto each depth plane. The left and right image data sets are data sets that represent two-dimensional images that are projected in three-dimensions to give the user a perception of a depth.

The stereoscopic analyzer 144 enters the left and right image data sets into the left and right projectors 166A and 166B. The left and right projectors 166A and 166B then create left and right light patterns. The components of the display system 42 are shown in plain view, although it should be understood that the left and right patterns are two-dimensional patterns when shown in front elevation view. Each light pattern includes a plurality of pixels. For purposes of illustration, light rays 624A and 626A from two of the pixels are shown leaving the left projector 166A and entering the left waveguide 170A. The light rays 624A and 626A reflect from sides of the left waveguide 170A. It is shown that the light rays 624A and 626A propagate through internal reflection from left to right within the left waveguide 170A, although it should be understood that the light rays 624A and 626A also propagate in a direction into the paper using refractory and reflective systems.

The light rays 624A and 626A exit the left light waveguide 170A through a pupil 628A and then enter a left eye 620A through a pupil 630A of the left eye 620A. The light rays 624A and 626A then fall on a retina 632A of the left eye 620A. In this manner, the left light pattern falls on the retina 632A of the left eye 620A. The user is given the perception that the pixels that are formed on the retina 632A are pixels 634A and 636A that the user perceives to be at some distance on a side of the left waveguide 170A opposing the left eye 620A. Depth perception is created by manipulating the focal length of the light.

In a similar manner, the stereoscopic analyzer 144 enters the right image data set into the right projector 166B. The right projector 166B transmits the right light pattern, which is represented by pixels in the form of light rays 624B and 626B. The light rays 624B and 626B reflect within the right waveguide 170B and exit through a pupil 628B. The light rays 624B and 626B then enter through a pupil 630B of the right eye 620B and fall on a retina 632B of a right eye 620B. The pixels of the light rays 624B and 626B are perceived as pixels 634B and 636B behind the right waveguide 170B.

The patterns that are created on the retinas 632A and 632B are individually perceived as left and right images. The left and right images differ slightly from one another due to the functioning of the stereoscopic analyzer 144. The left and right images are perceived in a mind of the user as a three-dimensional rendering.

As mentioned, the left and right waveguides 170A and 170B are transparent. Light from a real-life object such as the table 16 on a side of the left and right waveguides 170A and 170B opposing the eyes 620A and 620B can project through the left and right waveguides 170A and 170B and fall on the retinas 632A and 632B.

In one or more embodiments, the AR system can track eye pose (e.g., orientation, direction) and/or eye movement of one or more users in a physical space or environment (e.g., a physical room). The AR system may employ information (e.g., captured images or image data) collected by one or more sensors or transducers (e.g., cameras) positioned and oriented to detect pose and or movement of a user's eyes. For example, head worn components of individual AR systems may include one or more inward facing cameras and/or light sources to track a user's eyes.

As noted above, the AR system can track eye pose (e.g., orientation, direction) and eye movement of a user, and construct a “heap map”. A heat map may be a map of the world that tracks and records a time, frequency and number of eye pose instances directed at one or more virtual or real objects. For example, a heat map may provide information regarding what virtual and/or real objects produced the most number/time/frequency of eye gazes or stares. This may further allow the system to understand a user's interest in a particular virtual or real object.

Advantageously, in one or more embodiment, the heat map may be used in advertising or marketing purpose and to determine an effectiveness of an advertising campaign, in some embodiments. The AR system may generate or determine a heat map representing the areas in the space to which the user(s) are paying attention. In one or more embodiments, the AR system can render virtual content (e.g., virtual objects, virtual tools, and other virtual constructs, for instance applications, features, characters, text, digits, and other symbols), for example, with position and/or optical characteristics (e.g., color, luminosity, brightness) optimized based on eye tracking and/or the heat map.

In one or more embodiments, the AR system may employ pseudo-random noise in tracking eye pose or eye movement. For example, the head worn component of an individual AR system may include one or more light sources (e.g., LEDs) positioned and oriented to illuminate a user's eyes when the head worn component is worn by the user. The camera(s) detects light from the light sources which is returned from the eye(s). For example, the AR system may use Purkinje images 750, e.g., reflections of objects from the structure of the eye.

The AR system may vary a parameter of the light emitted by the light source to impose a recognizable pattern on emitted, and hence detected, light which is reflected from eye. For example, the AR system may pseudo-randomly vary an operating parameter of the light source to pseudo-randomly vary a parameter of the emitted light. For instance, the AR system may vary a length of emission (ON/OFF) of the light source(s). This facilitates automated detection of the emitted and reflected light from light emitted and reflected from ambient light sources.

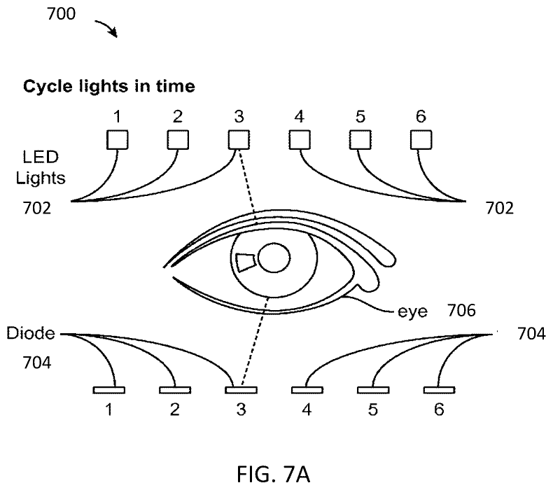

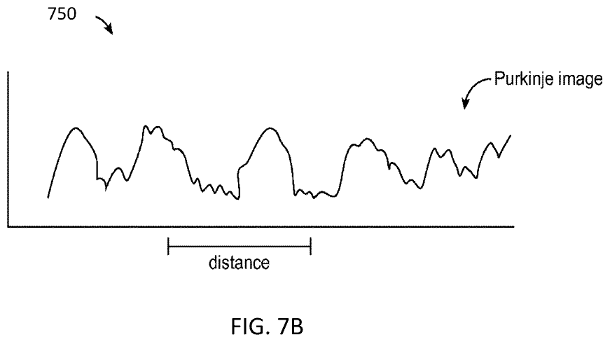

FIGS. 7A-7B illustrate simplified examples of eye tracking in some embodiments. As illustrated in FIG. 7A and FIG. 7B, in one implementation, light sources (e.g., LEDs) 702 are positioned on a frame to be on one side (e.g., top) of the eye 706 and sensors (e.g., photodiodes) are positioned on the bottom part of the frame. The eye may be seen as a reflector. Notably, one eye needs to be instrumented and tracked since pairs of eyes tend to move in tandem. The light sources 702 (e.g., LEDs) are normally turned ON and OFF one at a time (e.g., time slice) to produce a patterned code (e.g., amplitude variation or modulation). The AR system performs autocorrelation of signals produced by the sensor(s) (e.g., photodiode(s)) to determine a time-of-flight signal. In one or more embodiments, the AR system employs a known geometry of the light sources (e.g., LEDs), the sensor(s) (e.g., photodiodes), and distance to the eye.

The sum of vectors with the known geometry of the eye allows for eye tracking. When estimating the position of the eye, since the eye has a sclera and an eyeball, the geometry can be represented as two circles layered on top of each other. The eye pointing vector can be determined or calculated with no cameras. Also, the eye center of rotation may be estimated since the cross section of the eye is circular and the sclera swings through a particular angle. This actually results in a vector distance because of autocorrelation of the received signal against known transmitted signal, not just ray traces. The output may be seen as a Purkinje image 750, as shown in FIG. 7B, which may in turn be used to track movement of the eyes.

In some implementations, the light sources may emit in the infrared (IR) range of the electromagnetic spectrum, and the photosensors may be selectively responsive to electromagnetic energy in the IR range.

In one or more embodiments, light rays are emitted toward the user's eyes as shown in the illustrated embodiment. The AR system is configured to detect one or more characteristics associated with an interaction of the light with the user's eyes (e.g., Purkinje image 750, an extent of backscattered light detected by the photodiodes 704, a direction of the backscattered light, etc.). This may be captured by the photodiodes, as shown in the illustrated embodiments. One or more parameters of the interaction may be measured at the photodiodes. These parameters may in turn be used to extrapolate characteristics of eye movements or eye pose.

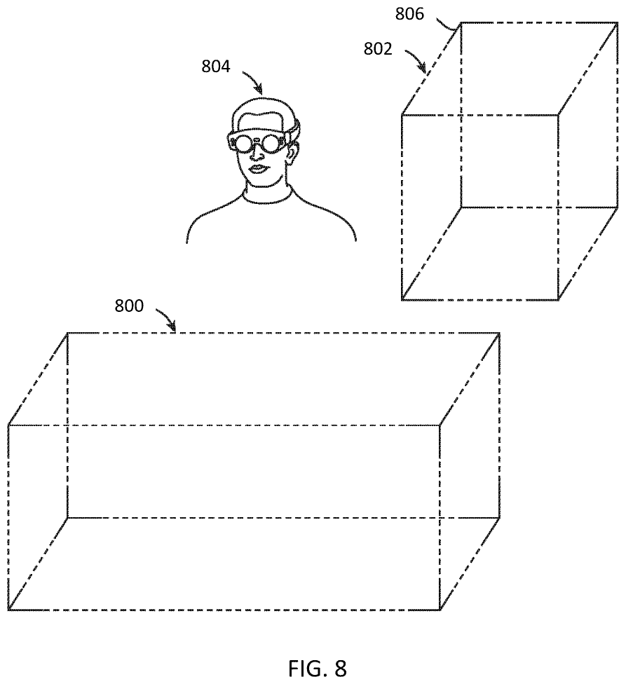

FIG. 8 illustrates a simplified example of universe browser prisms in one or more embodiments. In this example, two universe browser prisms (or simply prisms) 800 and 802 are created in a virtual 3D space for a user 804 wearing an extended-reality device. It shall be noted that although prisms 800 and 802 appear to be rectangular prisms, a prism may be of any shapes and sizes (e.g., cylinder, cube, sphere, tetrahedron, etc. or even irregular 3D volumes).

A prism is a three-dimensional volumetric space that virtual content is rendered and displayed into. A prism exists in a virtual 3D space provided by an extended reality system, and the virtual 3D space provided by an extended reality system may include more than one prism in some embodiments. In some embodiments, the one or more prisms by be placed in the real world (e.g., user's environment) thus providing one or more real world locations for the prisms. In some of these embodiments, the one or more prisms may be placed in the real world relative to one or more objects (e.g., a physical object, a virtual object, etc.), one or more two-dimensional surface (e.g., a surface of a physical object, a surface of a virtual object, etc.), and/or one or more one-dimensional points (e.g., a vertex of a physical object, a surface of a virtual object, etc.) In some embodiments, a single software application may correspond to more than one prism. In some embodiments, a single application corresponds to a single prism.

In some embodiments, a prism may represent a sub-tree of a multi-application scene graph for the current location of a user of an extended reality system in some embodiments. Retrieving the one or more prisms previously deployed at the current location of a user may comprise retrieving instance data for the one or more prisms, from an external database for example (e.g., a database storing a passable world model in a cloud environment), and reconstructing a local database (e.g., an internal passable world model database that comprises a smaller portion of the passable world model stored externally) with the instance data for the one or more prisms.

In some of these embodiments, the instance data for a prism includes a data structure of one or more prism properties defining the prism. The prism properties may comprise, for example, at least one of a location, an orientation, an extent width, an extent height, an extent depth, an anchor type, and/or an anchor position. In addition or in the alternative, the instance data for a prism may include key value pairs of one or more application specific properties such as state information of virtual content previously rendered into a prism by an application. In some embodiments, data may be entirely stored locally so that an external database is not needed.

A prism includes a 3D bounded space with a fixed and/or adjustable boundary upon creation in some embodiments although degenerated 3D prisms having a lower dimensionality are also contemplated. A prism, when generated, may be positioned (e.g., by a universe browser engine or an instance thereof) in the virtual 3D space of an XR system and/or a location in the user's environment or anywhere else in the real world. The boundary of a prism may be defined by the system (e.g., a universe browser engine), by a user, and/or by a developer of a Web page, based at least in part upon the size or extents of the content that is to be rendered within the prism. In some embodiments, only an XR system (e.g., a universe browser engine thereof) may create and/or adjust the boundary of a prism on the XR system. The boundary of a prism may be displayed (e.g., in a graphically deemphasized manner) in some embodiments. In some other embodiments, the boundary of a prism is not displayed.

The boundary of a prism defines a space within which virtual contents and/or rendered contents may be created. The boundary of a prism may also constrain where and how much a web page panel may be moved and rotated in some embodiments. For example, when a web page panel is to be positioned, rotated, and/or scaled such that at least a portion of the web page panel will be outside the prism, the system (e.g., a universe browser engine) may prevent such positioning, rotation, and/or scaling.

In some embodiments, the system may position, rotate, and/or scale the web page panel at the next possible position that is closest to or close to the original position, rotation, or scale in response to the original positioning, rotation, or scaling request in some embodiments. In some of these embodiments, the system may show a ghost image or frame of this next possible position, rotation, or scale and optionally display a message that indicates the original position, rotation, or scale may result in at least a portion of the web page panel being outside a prism.

Applications may render graphics into a prism via, at least in part, a universe browser engine. In some embodiments, a universe browser engine renders scene graphs and/or has full control over the positioning, rotation, scale, etc. of a prism. Moreover, a universe browser engine may provide the ability to attach one or more prisms to physical objects such as a wall, a surface, etc. and to register a prism with a passable world that may be shared among a plurality of XR system users described herein.

In addition or in the alternative, a universe browser engine may control sharing of contents between the plurality of XR system users. In some embodiments, a universe browser engine may also manage a prism. For example, a universe browser engine may create a prism, manage positioning and/or snapping rules relative to one or more physical objects, provide user interface controls (e.g., close button, action bar, navigation panel, etc.), keep track of records or data of a prism (e.g., what application owns or invokes which prism, where to place a prism, how a prism is anchored-body centric, world fixed, etc.)

In some embodiments, prism behavior may be based in part or in whole upon one or more anchors. In some embodiments, prism behaviors may be based, in part, on positioning, rotation, and/or scaling (e.g., user placement of web page content or the prism itself through a user interaction, a developer's positioning, rotation, and/or scaling of a web page panel, etc.) and/or body dynamics (e.g., billboard, body centric, lazy headlock, etc.) A prism may move within a 3D virtual space in some embodiments. In some of these embodiments, a universe browser engine may track the movement of a prism (e.g., billboarding to user/body-centric, lazy billboarding, sway when move, collision bounce, etc.) and manage the movement of the prism.

In addition or in the alternative, a prism including a browser, web page panels, and any other virtual contents, may be transformed in many different ways by applying corresponding transforms to the prism. For example, a prism can be moved, rotated, scaled, and/or morphed in the virtual 3D space. In some embodiments, a set of transforms is provided for the transformation of web pages, web page panels, browser windows, and prisms, etc. In some embodiments, a prism may be created automatically having a set of functionalities. The set of functionalities may comprise, for example, a minimum and/or maximum size allowed for the prism, and/or an aspect ratio for resizing the prism in some embodiments. The set of functionalities may comprise an association between a prism to the object (e.g., a virtual object, a physical object, etc.) in the virtual or physical 3D spatial environment. Additional virtual contents may be rendered into one or more additional prisms, wherein each virtual content may be rendered into a separate prism in some embodiments or two or more virtual contents may be rendered into the same prism in some other embodiments.

A prism may be completely transparent and thus invisible to the user in some embodiments or may be translucent and thus visible to the user in some other embodiments. Unlike conventional web pages that are displayed within a browser window, a browser window may be configurable (e.g., via the universe browser engine) to show or hide in the virtual 3D space. In some embodiments, the browser window may be hidden and thus invisible to the user, yet some browser controls (e.g., navigation, address bar, home icon, reload icon, bookmark bar, status bar, etc.) may still be visible in the virtual 3D space to the user. These browser controls may be displayed to be translated, rotated, and transformed with the corresponding web page in some embodiments or may be displayed independent of the corresponding web page in some other embodiments.

In some embodiments, a prism may not overlap with other prisms in a virtual 3D space. A prism may comprise one or more universal features to ensure different software applications interact appropriately with one another, and/or one or more application-specific features selected from a list of options.

In some embodiments, the vertices (806) of the prism may be displayed in a de-emphasized manner (e.g., reduced brightness, etc.) to the user so that the user is aware of the confines of the prism within which a virtual object or a rendered web page may be translated or rotated. In some embodiments where, for example, a web page or a web page panel is translated or rotated so that a portion of the web page or a web page panel falls outside of the confines defined by the prism, the system may nevertheless display the remaining portion of the web page or the web page panel that is still within the prism, but not display the portion of the web page that falls outside the confines of the prism. In some other embodiments, the extended-reality system confines the translation, rotation, and transformation of a web page or a web page panel so that the entire web page or web page panel can be freely translated, rotated, or transformed, yet subject to the confines of the boundaries of the prism.

As illustrated in FIG. 8, a virtual 3D space may include one or more prisms. Furthermore, a prism can also include one or more other prisms so that the prism may be regarded as the parent of the one or more other prisms in some embodiments. In some of these embodiments, a prism tree structure may be constructed where each node represents a prism, and the edge between two connected nodes represents the parent-child relationship between these two connected nodes. Two prisms can be moved in such a way to overlap one another or even to have one prism entirely included within the other prism. The inclusive relation between two prisms may or may not indicate that there is a parent child relationship between these two prisms, although the extended-reality system can be configured for a user to specify a parent-child relationship between two prisms. Furthermore, a first prism may or may not have to be entirely included in a second prism in order for a parent-child relationship to exist. In some embodiments, all child prisms inherit the transforms, translation, and rotation that have been or are to be applied to the parent prism so that the parent prism and its child prisms are transformed, translated, and rotated together.

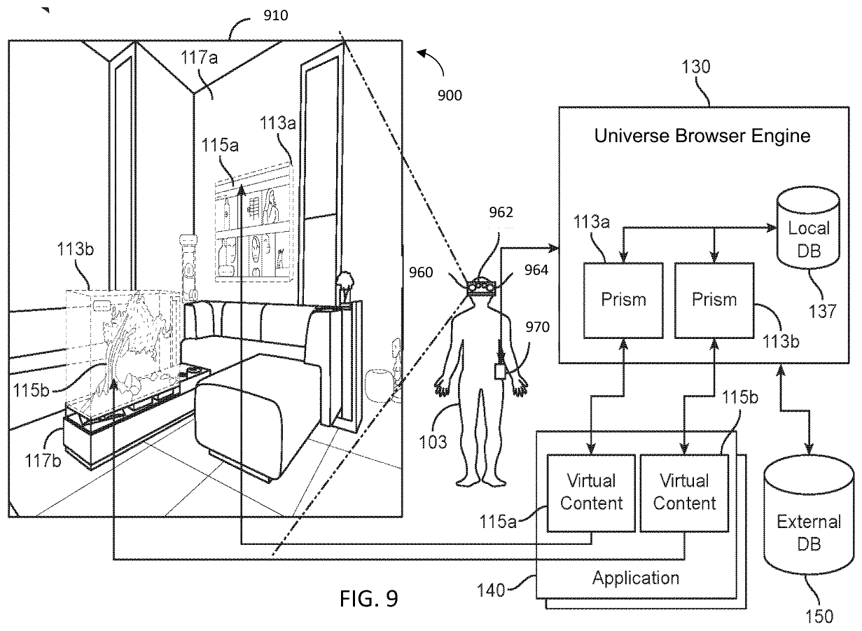

FIG. 9 illustrates an example user physical environment and system architecture for managing and displaying productivity applications and/or resources in a three-dimensional virtual space with an extended-reality system or device in one or more embodiments. More specifically, FIG. 9 illustrates an example user physical environment and system architecture for managing and displaying web pages and web resources in a virtual 3D space with an extended-reality system in one or more embodiments. The representative environment 900 includes a user's landscape 910 as viewed by a user 103 through a head-mounted system 960. The user's landscape 910 is a 3D view of the world where user-placed content may be composited on top of the real world. The representative environment 900 further includes accessing a universe application or universe browser engine 130 via a processor 970 operatively coupled to a network (not shown).

Although the processor 970 is shown as an isolated component separate from the head-mounted system 960, in an alternate embodiment, the processor 970 may be integrated with one or more components of the head-mounted system 960, and/or may be integrated into other system components within the representative environment 900 such as, for example, a network to access a computing network (not shown) and external storage device(s) 150. In some embodiments, the processor 970 may not be connected to a network. The processor 970 may be configured with software (e.g., a universe application or universe browser engine 130) for receiving and processing information such as video, audio, and/or other data (e.g., depth camera data) received from the head-mounted system 960, a local storage device 137, application(s) 140, a computing network, and/or external storage device(s) 150.

The universe application or universe browser engine 130 may be a 3D windows manager that is analogous to a 2D windows manager running on, for example, a desktop computer for managing 2D windows displayed on the display screen of the desktop computer. However, the universe application or universe browser engine 130 (hereinafter may be referred to as “the Universe” for simplicity) manages the creation, placement and display of virtual content 115 (115a and 115b) in a 3D spatial environment, as well as interactions between a plurality of virtual content 115 displayed in a user's landscape 910. Virtual content 115 from applications 140 are presented to users 903 inside of one or more 3D window display management units such as bounded volumes and/or 3D windows, hereinafter may be referred to as Prisms 113 (113a and 113b).

A bounded volume/3D window/Prism 113 may be a rectangular, cubic, cylindrical, or any other shape volume of space that may be positioned and oriented in space. A Prism 113 may be a volumetric display space having boundaries for content (e.g., virtual content) to be rendered/displayed into, wherein the boundaries are not displayed. In some embodiments, the boundaries may be displayed. The Prism 113 may present a standard base level of interaction and control over an application's content and its placement. The Prism 113 may represent a sub-tree of a multi-application scene graph, which may be embedded inside of the universe browser engine 130, or may be external to but accessed by the universe browser engine. A scene graph is a general data structure commonly used by vector-based graphics, editing applications and modern gaming software, which arranges the logical and often (but not necessarily) spatial representation of a graphical scene. A scene graph may be considered a data-structure that defines how content is positioned and transformed relative to each other within its structure. Application(s) 140 are given instances of Prisms 113 to place content within. Applications may render 2D/3D content within a Prism 113 using relative placement algorithms and arbitrary transforms, but the universe browser engine (130) may still ultimately be in charge of gross interaction patterns such as content extraction. Multiple applications may render to the universe browser engine (130) via the Prisms 113, with process boundaries separating the Prisms 113. There may be n number of bounded volumes/Prisms 113 per application process, but this is explicitly an n:1 relationship such that only one process for each application may be running for each bounded volume/Prism 113, but there may be a number of m processes running, each with their own bounded volume/Prism 113.

The universe browser engine (130) operates using a Prism/distributed scene graph approach for 2D and/or 3D content. A portion of the universe browser engine's scene graph is reserved for each application to render to. Each interaction with an application, for example the launcher menu, the landscape, or body-centric application zones (all described in more detail below) may be done through a multi-application scene graph. Each application may be allocated 1 to “n” rectangular Prisms that represent a sub-tree of the scene graph. Prisms are not allocated by the client-side applications, but instead are created through the interaction of the user inside of the universe browser engine (130), for example when the user opens a new application in the landscape by clicking a button on a controller. In some embodiments, an application can request a Prism from the universe browser engine (130), but the request may be denied. In some embodiments, if an application requests and is allowed a new Prism, the application may only transform the new Prism relative to one of its other Prisms.

The universe browser engine (130) comprises virtual content 115 from application(s) 140 in objects called Prisms 113. Each application process or instance may render its virtual content into its own individual Prism 113 or set of Prisms. The universe browser engine (130) manages a world space, sometimes called a landscape, where Prisms 113 are displayed. In some embodiments, the universe browser engine (130) provides the ability to attach applications to walls and surfaces, place Prisms at an arbitrary location in space, register them with the extended-reality system's world database, and/or control sharing of content between multiple users of the extended-reality system.

In some embodiments, the purpose of the Prisms 113 is to provide behaviors and control over the rendering and display of the content. Much like a 2D display, where a window may be used to define location, menu structures, and display of 2D content within a 2D window, with 3D virtual display, the Prism allows the extended-reality system (e.g., the universe browser engine (130)) to wrap control relating to, for example, content locations, 3D window behavior, and/or menu structures around the display of 3D content. For example, controls may include at least placing the virtual content in a particular location in the user's landscape 110, removing the virtual content from the landscape 110, copying the virtual content and/or placing the copy in a different location, etc. In some embodiments, Prisms may be created and destroyed by the user and only the user. This may be done explicitly to help control abuse of the interfaces provided and to help the user maintain control of the user's content.

Additionally, in some embodiments, application(s) 140 do not know where their volumes are placed in the landscape—only that they exist. In some embodiments, applications may request one or more Prisms, and the request may or may not be granted. After the new Prism is created, the user may change the position, and/or the application may automatically position the new Prism relative to a currently existing Prism associated with the application. In some embodiments, each application 140 making use of the universe browser engine's service to render 3D content (e.g., composited 3D content) into the universe browser engine process may be required to first register a listener with the universe browser engine. This listener may be used to inform the application 140 of creation and destruction of rendering Prisms, based upon user movement and user interaction with those Prisms. A listener is an interface object that receives messages from an inter-process communication system. For example, in the Android operating system, a listener is an object that receives messages through an Android Binder interface. However, any IPC system may be used such that a Binder is not always used.

In some embodiments, Prisms may be created from the following example interactions: (1) The user has extracted content from an extractable node (disclosed further below); (2) The user has started an application from the launcher; (3) The user has downloaded a nearby passable world map tile that includes a placed instance of an application that the user has permission to see; (4) The user has downloaded a nearby passable world map tile that includes an object that the passable world object recognizer infrastructure has detected, that a given application must render content for; and/or (5) The user has triggered a dispatch from another application that must be handled in a different application. In some embodiments, a passable world model allows a user to effectively pass over a piece of the user's world (e.g., ambient surroundings, interactions, etc.) to another user.

Extractable Content is content inside a Prism (including but not limited to an icon, 3D icon, word in a text display, and/or image) that can be pulled out of the Prism using an input device and placed in the landscape. For example, a Prism might display a web page showing a running shoe for sale. To extract the running shoe, the shoe can be selected and “pulled” with an input device. A new Prism would be created with a 3D model representing the shoe, and that Prism would move out of the original Prism and towards the user. Like any other Prism, the user may use an input device to move, grow, shrink or rotate the new Prism containing the shoe in the 3D space of the landscape. An Extractable Node is a node in the Prism's scene graph that has been tagged as something that can be extracted. In the universe browser engine, to extract content means to select an extractable node, and use an input device to pull the content out of the Prism. The input to initiate this pull could be aiming a 6 dof pointing device at extractable content and pulling the trigger on the input device.

Each user's respective individual extended-reality system (e.g., extended-reality devices) captures information as the user passes through or inhabits an environment, which the extended-reality system processes to produce a passable world model. More details regarding a passable world are described in U.S. patent application Ser. No. 14/205,126, filed on Mar. 11, 2014, entitled “SYSTEM AND METHOD FOR AUGMENTED AND EXTENDED-REALITY”, which is hereby explicitly incorporated by reference for all purposes. The individual extended-reality system may communicate or pass the passable world model to a common or shared collection of data, referred to as the cloud. The individual extended-reality system may communicate or pass the passable world model to other users, either directly or via the cloud. The passable world model provides the ability to efficiently communicate or pass information that essentially encompasses at least a field of view of a user. In one embodiment, the system uses the pose and orientation information, as well as collected 3D points described above in order to create the passable world.

In some embodiments, the passable world model allows the user the ability to integrate content (e.g., virtual and/or physical content) with the real world. A passable world system may include one or more extended-reality systems or extended-reality user devices that are able to connect to a cloud network, a passable world model, a set of object recognizers, and a database (e.g., external database 150). The passable world model may be configured to receive information from the extended-reality user devices and also transmit data to them through the network. For example, based on the input from a user, a piece of the passable world may be passed on from one user to another user. The passable world model may be thought of as a collection of images, points and other information (e.g., real-world information) based on which the extended-reality system is able to construct, update and build the virtual world on the cloud, and effectively pass pieces of the virtual world to various users. For example, a set of real-world points collected from an extended-reality user device may be collected in the passable world model. Various object recognizers may crawl through the passable world model to recognize objects, tag images, etc., and attach semantic information to the objects. The passable world model may use the database to build its knowledge of the world, attach semantic information, and store data associated with the passable world.

In the case of a Prism that is visible to the user but whose controlling application is not currently installed, the universe browser engine may render a temporary placeholder for that application that, when interacted with, redirects the user to the application store page for that application. In some embodiments, Prisms may be destroyed in similar interactions: (1) The user has walked far enough from a passable world map tile that the placed instance of an application has been unloaded (i.e., removed) from volatile memory; (2) The user has destroyed a placed instance of an application; and/or (3) An application has requested that a Prism be closed.

In some embodiments, if no Prisms for an application are visible and/or loaded, then the process associated with those Prisms may be paused or ended. Once a placed Prism for that application is visible again, the process may be restarted. Prisms may also be hidden, but, in some embodiments, this may only happen at the behest of the universe browser engine and the user. In some embodiments, multiple Prisms may be placed at the same exact location. In such embodiments, the universe browser engine may only show one instance of a placed Prism in one place at a time, and manage the rendering by hiding the visibility of a Prism (and its associated content) until a user interaction is detected, such as the user “swipes” to the next visible element (e.g., Prism) in that location.

In some embodiments, each Prism 113 may be exposed to the application 140 via a volume listener interface with methods for accessing properties of the Prism 113 and registering content in a scene graph sub-tree for shared resources such as meshes, textures, animations, and so on. In some embodiments, since the application 140 does not know where a given Prism 113 is placed in 3D space, the volume listener interface may provide accessor methods to a set of hints that help to define where the given Prism is present in the universe browser engine, for example hand centric, stuck in the landscape, Body Centric, etc. These properties additionally specify expected behavior of the Prisms, and may be controlled in a limited fashion either by the user, the application 140, or the universe browser engine. A given Prism can be positioned relative to another Prism that an application owns. Applications can specify that Prisms should snap together (two sides of their bounding volumes touch) while Prisms from that application are being placed. Additionally, Prisms may provide an API (e.g., 118B) for key-value data storage. Some of these key-value pairs are only writable by privileged applications.

In some embodiments, application(s) 140 are client software applications that provide content that is to be displayed to the user 103 in the user's landscape 110. For example, an application 140 may be a video streaming application, wherein video data may be streamed to the user to be displayed on a 2D planar surface. As another example, an application 140 may be a Halcyon application that provides 3D imaging of physical objects that may denote a period of time in the past that was idyllically happy and peaceful for the user. Application 140 provides the content that a user may want to include in the user's landscape 110. The universe browser engine via the Prisms 113 manages the placement and management of the content that is generated by application 140.

When a non-immersive application is executed/launched in the user's landscape 110, its content (e.g., virtual content) is rendered inside of a Prism 113. A non-immersive application may be an application that is able to run and/or display content simultaneously with one or more other applications in a shared 3D environment. Although the virtual content may be contained within the Prism, a user may still interact with the virtual content, such as, for example, hovering over an object, clicking on it, etc. The Prism 113 may also bound application 140′s displayed content so different applications 140 do not interfere with each other or other objects in the user's landscape 110. Prisms 113 may also provide a useful abstraction for suspending, pausing, and/or minimizing virtual content from application(s) 140 that are out of view or too far away from the user.

The Prisms 113 may be anchored/attached/pinned to various objects within a user's landscape 110, including snapping or anchoring to another Prism. For example, Prism 113a, which displays virtual content 115 (e.g., a video 115a from a video streaming application), may be anchored to a vertical wall 117a. As another example, Prism 113b, which displays a 3D tree 115b from a Halcyon application, is shown in FIG. 1 to be anchored to a table 117b. Furthermore, a Prism 113 may be anchored relative to a user 103 (e.g., body-centric), wherein the Prism 113 which displays virtual content 115 may be anchored to a user's body, such that as the user's body moves, the Prism 113 moves relative to the movement of the user's body. A body-centric content may be application content such as planes, meshes, etc. that follow the user and remain positionally consistent with the user. For example, a small dialog box that follows the user around but exists relative to the user's spine rather than the landscape 110. Additionally, a Prism 113 may also be anchored to a virtual object such as a virtual display monitor displayed within the user's landscape 110. The Prism 113 may be anchored in different ways, which is disclosed below.

The universe browser engine may include a local database 137 to store properties and characteristics of the Prisms 113 for the user. The stored Prism information may include Prisms activated by the user within the user's landscape 110. Local database 137 may be operatively coupled to an external database 150 that may reside in the cloud or in an external storage facility. External database 150 may be a persisted database that maintains information about the extended-reality environment of the user and of other users.

For example, as a user launches a new application to display virtual content in the user's physical environment, the local database 137 may store information corresponding to a Prism that is created and placed at a particular location by the universe browser engine, wherein an application 140 may render content into the Prism 113 to be displayed in the user's landscape 110. The information corresponding to the Prism 113, virtual content 115, and application 140 stored in the local database 137 may be synchronized to the external database 150 for persistent storage.

In some embodiments, the persisted storage may be important because when the extended-reality system is turned off, data stored in the local database 137 may be erased, deleted, or non-persisted. Thus, when a user turns on the extended-reality system, the universe browser engine may synchronize with the external database 150 to retrieve an instance of the local database 137 corresponding to the user 103 and the user's landscape 110 prior to the extended-reality system being turned off. The local database 137 may be an instance of the external database 150, wherein the instance of the local database 137 includes information pertinent to the user 103 and the user's current environment. The external database 150 may additionally store instances of local databases of other users, multiple users, the same user over time, and/or other environments. The external database 150 may contain information that is used to manage and share virtual content between multiple users of the extended-reality system, whereas the local database 137 stores and maintains information corresponding to the user 103.

The universe browser engine may create a Prism 113 for application 140 each time application(s) 140 needs to render virtual content 115 onto a user's landscape 110. In some embodiments, the Prism 113 created by the universe browser engine allows application 140 to focus on rendering virtual content for display while the universe browser engine focuses on creating and managing the placement and display of the Prism 113 having the virtual content 115 displayed within the boundaries of the Prism by the application 140.

Each virtual content 115 rendered by an application 140, displayed in the user's landscape 110, may be displayed within a single Prism 113. For example, if an application 140 needs to render two virtual contents (e.g., 115a and 115b) to be displayed within a user's landscape 110, then application 140 may render the two virtual contents 115a and 115b. Since virtual contents 115 include only the rendered virtual contents, the universe browser engine may create Prisms 113a and 113b to correspond with each of the virtual content 115 a and 115 b, respectively. The Prism 113 may include 3D windows management properties and characteristics of the virtual content 115 to allow the universe browser engine to manage the virtual content 115 inside the Prism 113 and the placement and display of the Prism 113 in the user's landscape 110.

The universe browser engine may be the first application a user 103 sees when the user 103 turns on the extended-reality device. The universe browser engine may be responsible for at least (1) rendering the user's world landscape; (2) 2D window management of planar applications and 3D windows (e.g., Prisms) management; (3) displaying and executing the application launcher menu; (4) allowing the user to place virtual content into the user's landscape 110; and/or (5) managing the different states of the display of the Prisms 113 within the user's landscape 110.

The head-mounted system 960 may be an extended-reality head-mounted system that includes a display system (e.g., a user interface) positioned in front of the eyes of the user 103, a speaker coupled to the head-mounted system and positioned adjacent the ear canal of the user, a user-sensing system, an environment sensing system, and a processor (all not shown). The head-mounted system 960 presents to the user 103 the display system (e.g., user interface) for interacting with and experiencing a digital world. Such interaction may involve the user and the digital world, one or more other users interfacing the representative environment 900, and objects within the digital and physical world.

The user interface may include viewing, selecting, positioning and managing virtual content via user input through the user interface. The user interface may be at least one or a combination of a haptics interface devices, a keyboard, a mouse, a joystick, a motion capture controller, an optical tracking device, an audio input device, a smartphone, a tablet, or the head-mounted system 960. A haptics interface device is a device that allows a human to interact with a computer through bodily sensations and movements. Haptics refers to a type of human-computer interaction technology that encompasses tactile feedback or other bodily sensations to perform actions or processes on a computing device.

An example of a haptics controller may be a totem (not shown). In some embodiments, a totem is a hand-held controller that tracks its position and orientation relative to the headset 960. In this example, the totem may be a six degree-of-freedom (six DOF) controller where a user may move a Prism around in altitude and azimuth (on a spherical shell) by moving the totem up or down. In some embodiments, to move the object closer or farther away, the user may use the joystick on the totem to “push” or “pull” the Prism, or may simply move the totem forward or backward. This may have the effect of changing the radius of the shell. In some embodiments, two buttons on the totem may cause the Prism to grow or shrink. In some embodiments, rotating the totem itself may rotate the Prism. Other totem manipulations and configurations may be used, and should not be limited to the embodiments described above.

The user-sensing system may include one or more sensors 962 operable to detect certain features, characteristics, or information related to the user 103 wearing the head-mounted system 960. For example, in some embodiments, the sensors 962 may include a camera or optical detection/scanning circuitry capable of detecting real-time optical characteristics/measurements of the user 103 such as, for example, one or more of the following: pupil constriction/dilation, angular measurement/positioning of each pupil, sphericity, eye shape (as eye shape changes over time) and other anatomic data. This data may provide, or be used to calculate information (e.g., the user's visual focal point) that may be used by the head-mounted system 960 to enhance the user's viewing experience.

The environment-sensing system may include one or more sensors 964 for obtaining data from the user's landscape 910. Objects or information detected by the sensors 964 may be provided as input to the head-mounted system 960. In some embodiments, this input may represent user interaction with the virtual world. For example, a user (e.g., the user 103) viewing a virtual keyboard on a desk may gesture with their fingers as if the user were typing on the virtual keyboard. The motion of the fingers moving may be captured by the sensors 964 and provided to the head-mounted system 960 as input, wherein the input may be used to change the virtual world or create new virtual objects.

The sensors 964 may include, for example, a generally outward-facing camera or a scanner for capturing and interpreting scene information, for example, through continuously and/or intermittently projected infrared structured light. The environment-sensing system may be used for mapping one or more elements of the user's landscape 910 around the user 103 by detecting and registering one or more elements from the local environment, including static objects, dynamic objects, people, gestures and various lighting, atmospheric and acoustic conditions, etc. Thus, in some embodiments, the environment-sensing system may include image-based 3D reconstruction software embedded in a local computing system (e.g., the processor 170) and operable to digitally reconstruct one or more objects or information detected by the sensors 964.

In some embodiments, the environment-sensing system provides one or more of the following: motion capture data (including gesture recognition), depth sensing, facial recognition, object recognition, unique object feature recognition, voice/audio recognition and processing, acoustic source localization, noise reduction, infrared or similar laser projection, as well as monochrome and/or color CMOS (Complementary metal-oxide-semiconductor) sensors (or other similar sensors), field-of-view sensors, and a variety of other optical-enhancing sensors. It should be appreciated that the environment-sensing system may include other components other than those discussed above.

As mentioned above, the processor 970 may, in some embodiments, be integrated with other components of the head-mounted system 960, integrated with other components of the system of the representative environment 900, or may be an isolated device (wearable or separate from the user 103). The processor 970 may be connected to various components of the head-mounted system 960 through a physical, wired connection, or through a wireless connection such as, for example, mobile network connections (including cellular telephone and data networks), Wi-Fi, Bluetooth, or any other wireless connection protocol. The processor 970 may include a memory module, integrated and/or additional graphics processing unit, wireless and/or wired internet connectivity, and codec and/or firmware capable of transforming data from a source (e.g., a computing network, and the user-sensing system and the environment-sensing system from the head-mounted system 960) into image and audio data, wherein the images/video and audio may be presented to the user 103 via the user interface (not shown).

The processor 970 handles data processing for the various components of the head-mounted system 960 as well as data exchange between the head-mounted system 960 and the software applications such as the universe browser engine, the external database 150, etc. For example, the processor 970 may be used to buffer and process data streaming between the user 103 and the computing network, including the software applications, thereby enabling a smooth, continuous and high-fidelity user experience. The processor 970 may be configured to execute a set of program code instructions. The processor 970 may include a memory to hold the set of program code instructions, in which the set of program code instructions comprises program code to display virtual content within a subset of available 3D displayable space by displaying the virtual content within a volumetric display space, wherein boundaries of the volumetric display space are not displayed. In some embodiments, the processor may be two or more processors operatively coupled.

In some embodiments, the extended-reality system may be configured to assign to a Prism universal features and application selected/application-specific features from a list of pre-approved options for configurations of display customizations by an application. For example, universal features ensure different applications interact well together. Some examples of universal features may include max/min size, no overlapping Prisms (excluding temporary overlap from collision behavior), no displaying content outside the boundaries of the Prism, applications need permission from user if the application wants to access sensors or sensitive information. Application selected/application-specific features enable optimized application experiences.

Application-selected/application-specific features may include max/min size (within limits from the system), default size (within limits from the system), type of body dynamic (e.g., none/world lock, billboard, edge billboard, follow/lazy headlock, follow based on external sensor, fade-- discussed below), child Prism spawn location, child head pose highlight, child Prism relational behavior, on surface behavior, independent transformation control, resize vs. scale, idle state timeout, collision behavior, permission/password to access application, etc. In another embodiment, the extended-reality system may be configured to display virtual content into one or more Prisms, wherein the one or more Prisms do not overlap with one another, in some embodiments.

In some embodiments, one or more Prisms may overlap in order to provide specific interactions. In some embodiments, one or more Prisms may overlap, but only with other Prisms from the same application. In another embodiment, the extended-reality system may be configured to change a state of a Prism based at least in part on a relative position and location of the Prism to a user. In another embodiment, the extended-reality system may be configured to manage content creation in an application and manage content display in a separate application. In another embodiment, the extended-reality system may be configured to open an application that will provide content into a Prism while simultaneously placing the Prism in an extended-reality environment.

In some embodiments, the extended-reality system may be configured to assign location, orientation, and extent data to a Prism for displaying virtual content within the Prism, where the virtual content is 3D virtual content. In some embodiments, the extended-reality system may be configured to pin a launcher application to a real-world object within an extended-reality environment. In some embodiments, the extended-reality system may be configured to assign a behavior type to each Prism, the behavior type comprising at least one of a world lock, a billboard, an edge billboard, a follow headlock, a follow based on external sensor, or a fade (described below in more detail). In some embodiments, the extended-reality system may be configured to identify a most used content or an application that is specific to a placed location of a launcher application, and consequently re-order to the applications from most to least frequently used, for example. In another embodiment, the extended-reality system may be configured to display favorite applications at a placed launcher application, the favorite applications based at least in part on context relative to a location of the placed launcher.

### System Architecture Overview

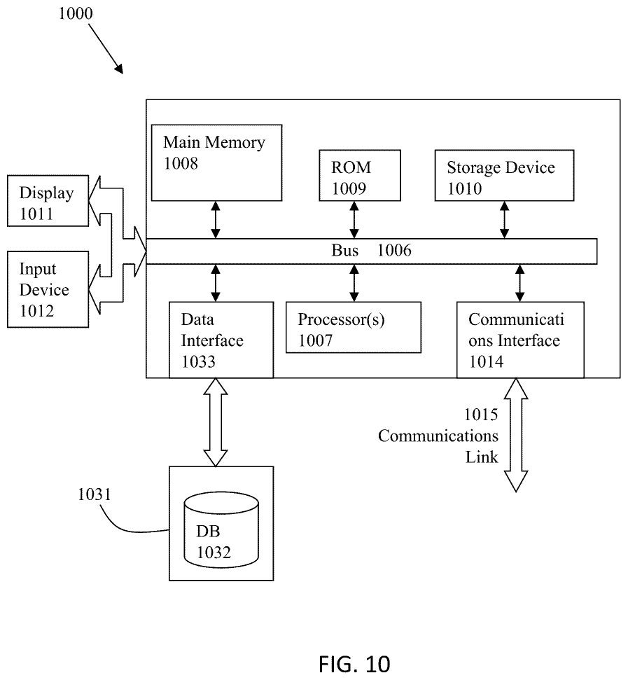

FIG. 10 illustrates a computerized system on which a method for management of extended-reality systems or devices may be implemented. Computer system 1000 includes a bus 1006 or other communication module for communicating information, which interconnects subsystems and devices, such as processor 1007, system memory 1008 (e.g., RAM), static storage device 1009 (e.g., ROM), disk drive 1010 (e.g., magnetic or optical), communication interface 1014 (e.g., modem or Ethernet card), display 1011 (e.g., CRT or LCD), input device 1012 (e.g., keyboard), and cursor control (not shown). The illustrative computing system 1000 may include an Internet-based computing platform providing a shared pool of configurable computer processing resources (e.g., computer networks, servers, storage, applications, services, etc.) and data to other computers and devices in a ubiquitous, on-demand basis via the Internet. For example, the computing system 1000 may include or may be a part of a cloud computing platform in some embodiments.

According to one embodiment, computer system 1000 performs specific operations by one or more processor or processor cores 1007 executing one or more sequences of one or more instructions contained in system memory 1008. Such instructions may be read into system memory 1008 from another computer readable/usable storage medium, such as static storage device 1009 or disk drive 1010. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

Various actions or processes as described in the preceding paragraphs may be performed by using one or more processors, one or more processor cores, or combination thereof 1007, where the one or more processors, one or more processor cores, or combination thereof executes one or more threads. For example, various acts of determination, identification, synchronization, calculation of graphical coordinates, rendering, transforming, translating, rotating, generating software objects, placement, assignments, association, etc. may be performed by one or more processors, one or more processor cores, or combination thereof.

The term “computer readable storage medium” or “computer usable storage medium” as used herein refers to any non-transitory medium that participates in providing instructions to processor 1007 for execution. Such a medium may take many forms, including but not limited to, non-volatile media and volatile media. Non-volatile media includes, for example, optical or magnetic disks, such as disk drive 1010. Volatile media includes dynamic memory, such as system memory 1008. Common forms of computer readable storage media includes, for example, electromechanical disk drives (such as a floppy disk, a flexible disk, or a hard disk), a flash-based, RAM-based (such as SRAM, DRAM, SDRAM, DDR, MRAM, etc.), or any other solid-state drives (SSD), magnetic tape, any other magnetic or magneto-optical medium, CD-ROM, any other optical medium, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1000. According to other embodiments, two or more computer systems 1000 coupled by communication link 1015 (e.g., LAN, PTSN, or wireless network) may perform the sequence of instructions required to practice the invention in coordination with one another.

Computer system 1000 may transmit and receive messages, data, and instructions, including program (e.g., application code) through communication link 1015 and communication interface 1014. Received program code may be executed by processor 1007 as it is received, and/or stored in disk drive 1010, or other non-volatile storage for later execution. In an embodiment, the computer system 1000 operates in conjunction with a data storage system 1031, e.g., a data storage system 1031 that includes a database 1032 that is readily accessible by the computer system 1000. The computer system 1000 communicates with the data storage system 1031 through a data interface 1033. A data interface 1033, which is coupled to the bus 1006 (e.g., memory bus, system bus, data bus, etc.), transmits and receives electrical, electromagnetic or optical signals that include data streams representing various types of signal information, e.g., instructions, messages and data. In embodiments of the invention, the functions of the data interface 1033 may be performed by the communication interface 1014.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. A machine implemented method, comprising:
presenting, by an extended-reality device, a first target at a first location and a second target at a second location to a user, wherein the first target is perceived as closer to the user than the second target;
aligning the first target and the second target with each other at least by performing an alignment process that moves the first target or the second target relative to the user; and
determining a nodal point for an eye of the user based at least in part upon the first target and the second target.

2. The machine implemented method of claim 1, determining the nodal point for the eye comprising:
determining a first line or line segment connecting the first target and the second target;
determining the nodal point for the eye along the first line or the line segment based at least in part upon a first depth pertaining to the first target or a second depth pertaining to the second target; and
presenting a third target at a third location and a fourth target at a fourth location to the user, wherein the third target is perceived as closer to the user than the fourth target.

3. The machine implemented method of claim 2, determining the nodal point for the eye further comprising:
determining a second line or line segment connecting the third target and the fourth target; and
determining the nodal point for the eye based at least in part upon the first line or line segment and the second line or line segment.

4. A machine implemented method, comprising:
identifying pixel coordinates for an extended-reality device;
determining a first set of pixel coordinates for a first location of a first target;
presenting, by the extended-reality device, the first target at the first set of pixel coordinates and a second target at a second location to a user; and
aligning the first target with the second target as perceived by the user.

5. The machine implemented method of claim 4, further comprising:
determining a three-dimensional location of a nodal point of an eye for the user based at least in part upon a result of aligning the first target with the second target.

6. The machine implemented method of claim 5, further comprising:
determining a second set of pixel coordinates for the second location of the second target.

7. The machine implemented method of claim 4, wherein the first location comprises a fixed location, and the second location comprises a movable location.

8. The machine implemented method of claim 4, wherein the first location comprises a movable location, and the second location comprises a fixed location.

9. The machine implemented method of claim 4, wherein the first location comprises a first fixed location, and the second location comprises a second fixed location, and the three-dimensional location of the nodal point is determined based at least in part upon the first fixed location, the second fixed location, and a result of aligning the first target to the second target as perceived by the user.

10. The machine implemented method of claim 4, identifying the pixel coordinates for the extended-reality device further comprising:
identifying world coordinates for the extended-reality device; and
determining a set of world coordinates for the second location of the target, wherein
the first target is presented at the first set of pixel coordinates for the extended-reality device as perceived by the user, and
the second target is presented at the set of world coordinates as perceived by the user.

11. The machine implemented method of claim 10, wherein the first location is a first fixed location, and the second location is a second fixed location, as perceived by the user.

12. The machine implemented method of claim 10, wherein the three-dimensional location of the nodal point of the eye for the user is determined based at least in part upon the set of world coordinates for the second target and the first set of pixel coordinates for the first target.

13. A machine implemented method, comprising:
spatially registering a set of targets comprising at least the first target and the second target in a display portion of a user interface of the extended-reality device;
triggering an execution of a device fit process in response to receiving a device fit check signal sent by the extended-reality device; and
adjusting a relative position of the extended-reality device to the user based at least in part upon a result of the device fit process.

14. (canceled)

15. (canceled)
